(19) United States
(12) Patent Application Publication
(10) Pub. No.: US 2026/0295694 A1
(43) Pub. Date: Oct. 1, 2026

(54) STATIONARY MACHINING DEVICE

(71) Applicant: MAKITA CORPORATION, Anjo-shi (JP)

(72) Inventors: Ryota KITAOKA, Anjo-shi (JP); Toshiyuki KANI, Anjo-shi (JP)

(73) Assignee: MAKITA CORPORATION, Anjo-shi (JP)

(21) Appl. No.: 19/634,972

(22) Filed: Mar. 31, 2026

(30) Foreign Application Priority Data
Mar. 31, 2025 (JP) 2025-058176

(51) Int. Cl. B23D 47/02; B23Q 3/00; B23D 45/04

(52) U.S. Cl. CPC B23D 47/025; B23Q 3/005; B23D 45/044

(57) ABSTRACT

A stationary machining device has an upper table, a rail and a fence body. On the upper table, a workpiece is placed, which moves from front to rear during machining. The rail extends left and right along a rear portion of the upper table. The fence body is disposed on the upper table for guiding the workpiece during machining. The stationary machining device has a support member and a pressing member. The support member is provided at a rear portion of the fence body and movably attached to the rail. The pressing member is provided at a front portion of the fence body and pushes a front portion of the upper table forward, cooperating with the support member to fix the fence body on the table.

### CROSS-REFERENCE TO RELATED APPLICATIONS

This application claims priority to Japanese patent application serial number 2025-058176 filed Mar. 31, 2025, the contents of which are incorporated herein by reference in their entirety for all purposes.

### BACKGROUND

The present disclosure relates to, for example, a stationary machining device for machining a workpiece placed on a table.

JP2012-76192A discloses a tabletop miter saw as an example for a stationary machining device. The tabletop miter saw has two placing surfaces such as a table below the saw blade and an upper table above the saw blade. The tabletop miter saw may be selectively used in two modes: tabletop miter saw mode used as a tabletop miter saw, and table saw mode used as a table saw. In the tabletop miter saw mode, the cutting tool unit is pivoted downward so that the lower portion of the rotating saw blade cuts a workpiece placed on the table. In the table saw mode, the workpiece placed on the upper table is fed toward the upper portion of the rotating saw blade protruding above the upper table to cut the workpiece.

When using in a table saw mode, a rip fence may be mounted on an upper table. The rip fence is mounted at a predetermined distance from a saw blade in an orthogonal direction of the saw blade. The rip fence is mounted in an orientation extending in the front-rear direction in parallel to the saw blade on the upper surface of the upper table. A workpiece is fed toward the rotating saw blade with the side of the workpiece pressed against the rip fence. This allows the workpiece to be cut straight with a constant width.

As disclosed in JP2012-76192A, a rip fence used in a conventional tabletop miter saw may be fixed merely at its front end to the upper table. As the rear portion of the rip fence is free, the rip fence may deflect when the workpiece is pressed against the rip fence. In other words, there was room for improvement to maintain the rigidity of the rip fence mounted on the upper table. There was also room for improvement regarding the fixability when mounting the rip fence on the upper table.

Therefore, there has been a need for a stationary machining device that can securely fix the rip fence on the table.

### SUMMARY

According to one aspect of the present disclosure, a stationary machining device includes a table, a rail and a fence body. A workpiece that moves front to rear when machining is placed on the table. The rail extends left and right along a rear portion of the table. The fence body is disposed on the table and guides the workpiece while machining. The stationary machining device includes a support member and a pressing member. The support member is provided at a rear of the fence body and movably attached to the rail. The pressing member is provided at a front of the fence body and pushes a front of the table forward, cooperating with the support member to fix the fence body on the table.

Therefore, by interposing the table between the support member and the pressing member in the front-rear direction, the fence body of the rip fence can be securely fixed to the table. The operability for fixing the rip fence to the table can also be enhanced by providing the pressing member at the front side where the operator is positioned during cutting.

### BRIEF DESCRIPTION OF THE DRAWINGS

FIG. 1 is a perspective view of the tabletop miter saw according to a first embodiment of the present disclosure.

FIG. 2 is a right side view of the tabletop miter saw in a table saw mode.

FIG. 3 is a right side view with a battery removed from FIG. 2.

FIG. 4 is a cross-sectional view taken along an imaginary plane passing through a saw blade in the state shown in FIG. 2.

FIG. 5 is a right side view of a battery attachment portion with a housing removed.

FIG. 6 is a perspective view of a rear guide mechanism and an elevating mechanism as seen from right front side.

FIG. 7 is a right side view of the tabletop miter saw when the cutting tool unit is at the bottom dead center in a tabletop miter saw mode.

FIG. 8 is a cross-sectional view taken along an imaginary plane passing through the saw blade in the state shown in FIG. 7.

FIG. 9 is a right side view of the tabletop miter saw when the cutting tool unit is at the top dead center in the tabletop miter saw mode.

FIG. 10 is a cross-sectional view taken along an imaginary plane passing through the saw blade in the state shown in FIG. 9.

FIG. 11 is a right side view of a right area of a fixed cover in the state shown FIG. 9.

FIG. 12 is a right side view of an auxiliary cover as it begins to open by pivoting downward from FIG. 9.

FIG. 13 is a right side view of the right side of the auxiliary cover as it is pivoted further downward from FIG. 12.

FIG. 14 is a top view of the state shown in FIG. 2.

FIG. 15 is an enlarged view of a portion XV in FIG. 14.

FIG. 16 is a top view with an upper table and an upper cover removed from FIG. 14.

FIG. 17 is a cross-sectional view taken along the line XVII-XVII in FIG. 2.

FIG. 18 is a left side view of the state shown in FIG. 2.

FIG. 19 is a left side view of the state shown in FIG. 7.

FIG. 20 is a left side view of the state shown in FIG. 9.

FIG. 21 is a left side view when being in an intermediate position between the top dead center and the bottom dead center.

FIG. 22 is a front view of the state shown in FIG. 2.

FIG. 23 is a cross-sectional view taken along the line XXIII-XXIII in FIG. 2.

FIG. 24 is a cross-sectional view taken along a line XXIV-XXIV in FIG. 3.

FIG. 25 is a front view of the state shown in FIG. 7.

FIG. 26 is a front view of the state shown in FIG. 9.

FIG. 27 is a view of the state shown in FIG. 9 as seen from front upper side.

FIG. 28 is a top view of the tabletop miter saw with the cutting tool unit tilted 45° to the left and the user's side rotated 45° to the right.

FIG. 29 is a view as seen from a XXIX direction of FIG. 28.

FIG. 30 is a right side view of a rip fence.

FIG. 31 is a bottom view of the rip fence.

FIG. 32 is a cross-sectional view taken along the line XXXII-XXXII in FIG. 14.

FIG. 33 is an exploded perspective view of a support member of the rip fence.

FIG. 34 is a perspective view of a blade cover.

FIG. 35 is a top view of the blade cover.

FIG. 36 is a cross-sectional view taken along the line XXXVI-XXXXVI in FIG. 35.

FIG. 37 is a perspective view of the tabletop miter saw according to a second embodiment of the present disclosure.

### DETAILED DESCRIPTION

According to another aspect of the present disclosure, the rail has a first upright surface oriented rearward. The support member has a tongue piece extending rearward from the first upright surface. A sliding member is provided that is mounted on one of the first upright surface and the tongue piece and slidably moves with respect to the other. Therefore, it is possible to maintain the rip fence to be fixed to the table by allowing the first upright surface and the tongue piece to face each other in the front-right direction. Furthermore, slidable movement of the first upright surface or the tongue piece with respect to the sliding member allows the rip fence to smoothly move with respect to the rail in the left-right direction. This improves the positioning accuracy of the rip fence relative to the table.

According to another aspect of the present disclosure, the rail has the first upright surface oriented rearward. The sliding member that contacts the first upright surface from rear and moves slidably is attached to the support member. Therefore, with the table interposed between the pressing member and the sliding member provided to the support member in the front-rear direction, the rip fence can be securely fixed to the table. Further, the slidability of the rail and the support member may be maintained while providing the rail to have a simple structure.

According to another aspect of the present disclosure, the sliding member may be made of epoxy resin, polyurethane resin or acetal resin. Therefore, wear of the sliding member may be suppressed against repeated sliding.

According to another aspect of the present disclosure, the sliding member may be made of polyacetal. Therefore, the sliding performance of the sliding member may be enhanced. Furthermore, when applying pressing force to the front surface of the table via the pressing member, the high sliding performance of the sliding member enables alignment of the support member's position. Consequently, warping of the support member relative to the rail can be suppressed.

According to another aspect of the present disclosure, the stationary machining device includes a front sliding member. The front sliding member is mounted on one of a front lower surface of the fence body and a front upper surface of the table, and slidably moves with respect to the other. The front sliding member is made of epoxy resin, polyurethane resin or acetal resin. Therefore, the rear sliding member and the front sliding member cooperate to enhance the sliding performance of the rip fence relative to the table.

According to another aspect of the present disclosure, the rail has a bottom surface, a second upright surface and a groove. The bottom surface extends rearward from a lower end of the first upright surface. The second upright surface stands upward from a rear end of the bottom surface. The groove is defined by the first upright surface, bottom surface and the second upright surface, and into which the sliding member is inserted. Therefore, the sliding member is inserted between the first upright surface and the second upright surface in the front-rear direction. This allows the sliding member to be favorably fixed within the groove of the rail when applying the pressing force rearward with the pressing member.

According to another aspect of the present disclosure, the first upright surface inclines upward towards the rear. Therefore, when the rip fence is fixed to the table, the sliding member may be prevented from slipping upward out of the rail.

According to another aspect of the present disclosure, the support member has a rail-side support body, a fence-side support body, a connecting mechanism, and a positioning mechanism. The rail-side support body slidably moves relative to the rail. The fence-side support body is fixed to the fence body. The connecting mechanism connects the rail-side support body and the fence-side support body so as to be position adjustable in a horizontal direction. The positioning mechanism aligns a position of the fence-side support body with respect to the rail-side support body. Therefore, a perpendicularity of the fence body with respect to the rail can be adjusted by aligning the horizontal position of the fence-side support body with respect to the rail-side support body. This allows a parallelism of the fence body with respect to an extension direction (front-rear direction) of a side surface of the saw blade to be adjusted.

According to another aspect of the present disclosure, the fence-side support body is provided with a receiving portion into which the rail-side support body is inserted from the rear. Accordingly, the connecting mechanism and the positioning mechanism can be provided in a compact manner.

According to another aspect of the present disclosure, the rail-side support body is tapered toward the front as seen in a plan view. Therefore, a front portion of the rail-side support body far from the rail has a greater allowable range of movement in the left-rear direction relative to the fence-side support body. Accordingly, the adjustment range of the perpendicularity of the fence body with respect to the rail can be increased. As a result, the adjustment range of the parallelism of the fence body in the front-rear direction may be increased.

According to another aspect of the present disclosure, the connecting mechanism has a screw member, a cylindrical bore, and a female thread. The cylindrical bore is provided in the fence-side support body into which the screw member is inserted from above and allow a radial movement of the screw member. The female thread is provided in the rail-side support body into which a leg of the screw member is screwed. The positioning mechanism includes a screw member having a head that contacts the upper surface of the cylindrical bore by screwing the screw member into the female thread. Accordingly, the screw member can be tightened or loosened from above the fence body. Therefore, the operability for positioning the fence-side support body relative to the rail-side support body may be improved.

According to another aspect of the present disclosure, the fence-side support body includes a front cylindrical bore and a rear cylindrical bore that are positioned at the front and rear as a cylindrical bore. A radial clearance between the rear cylindrical bore and a rear screw member that is the screw member inserted into the rear cylindrical bore is smaller than a radial clearance between the front cylindrical bore and a front screw member that is the screw member inserted into the front cylindrical bore. The fence body is therefore allowed to rotate utilizing the radial clearance between the front cylindrical bore and the front screw member with the rear screw member, which is inserted into the rear cylindrical bore, as a center of rotation of the fence body. As a result, the operability for positioning the fence-side support body relative to the rail-side support boy may be improved.

According to another aspect of the present disclosure, a length of the rail-side support body in the front-rear direction is one-third or less than a length of the fence body in the front-rear direction. Therefore, the adjustment range of the parallelism of the fence body in the front-rear direction may be increased.

According to another aspect of the present disclosure, an insertion hole is formed in a lateral side of the fence body. A lock screw for fixing the fence-side support body to the fence body is inserted into the insertion hole. A female thread into which the lock screw is screwed is formed in the lateral side of the fence-side support body. Therefore, when fixing the rip fence on the table utilizing the pressing force of the pressing member, the horizontal displacement of the fence-side support body relative to the fence body may be prevented. This allows the rip fence to be fixed to the table as the pressing member presses the table with minimal pressing force.

According to another aspect of the present disclosure, the fence body has a fence base, a material contact member and a material contact face. The fence base is supported by the support member. The material contact member is attached to the fence base so as to be position adjustable in the front-rear direction. The material contact face is provided on the material contact member for the workpiece to come in contact. Therefore, the material contact face of the material contact member is located between the fence base and the saw blade in the left-right direction. By adjusting a front and rear position of the material contact face, it is possible to prevent the workpiece from being stuck between the rip fence fixed on the table and a riving knife located behind the saw blade.

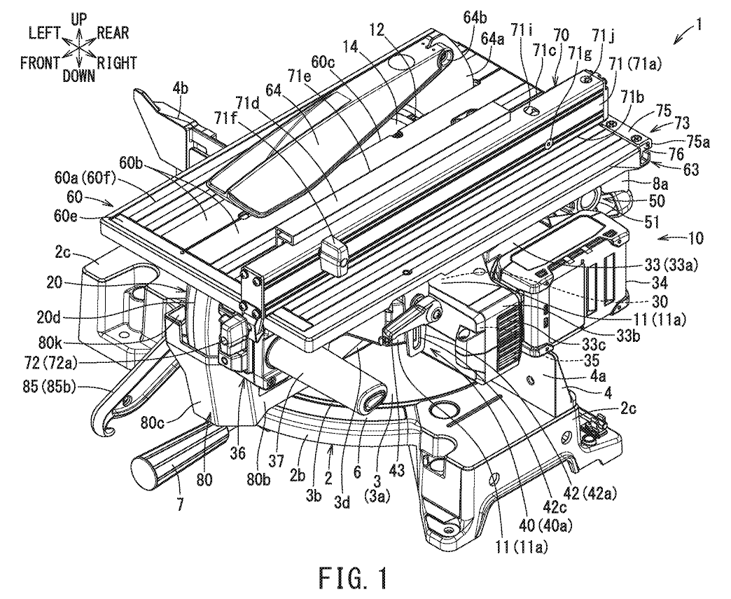

Referring to FIGS. 1 to 36, a first embodiment of the present disclosure is described below. In the present embodiment, a tabletop miter saw 1 is illustrated as an example of a stationary machining device and also known as a table miter saw or miter table saw. As shown in FIG. 1, the tabletop miter saw 1 has a base 2, which is placed on a tabletop or floor, and a turntable (table) 3 for placing a workpiece W. The turntable 3 is supported above the base 2. A cutting tool unit 10 is provided above the turntable 3. A substantially disk-shaped saw blade 14, commonly referred to as a tipped saw blade, is rotatably supported by the cutting tool unit 10. An upper table 60 for placing a workpiece is provided above the cutting tool unit 10. A user is typically positioned in front of the tabletop miter saw 1 to perform the cutting operation. In the following description, the front side is determined as the front side in the front-rear direction as seen from the user. The up-down and left-right directions are defined based on the user’s position.

### Overall Configuration of Tabletop Miter Saw 1 with Upper Table

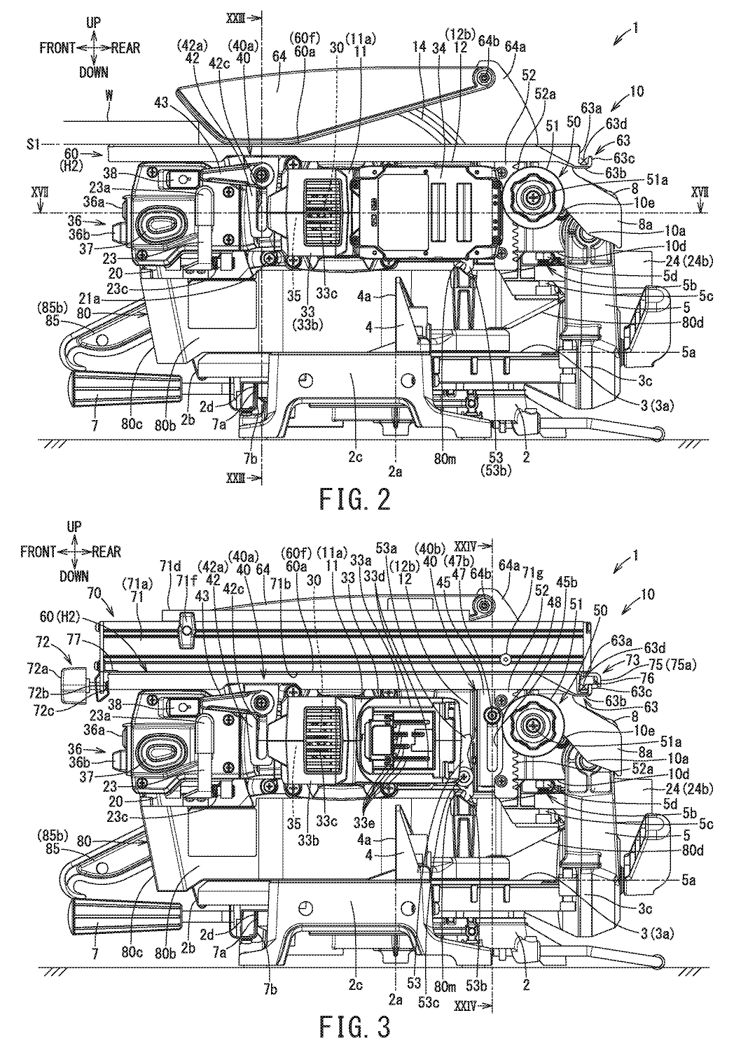

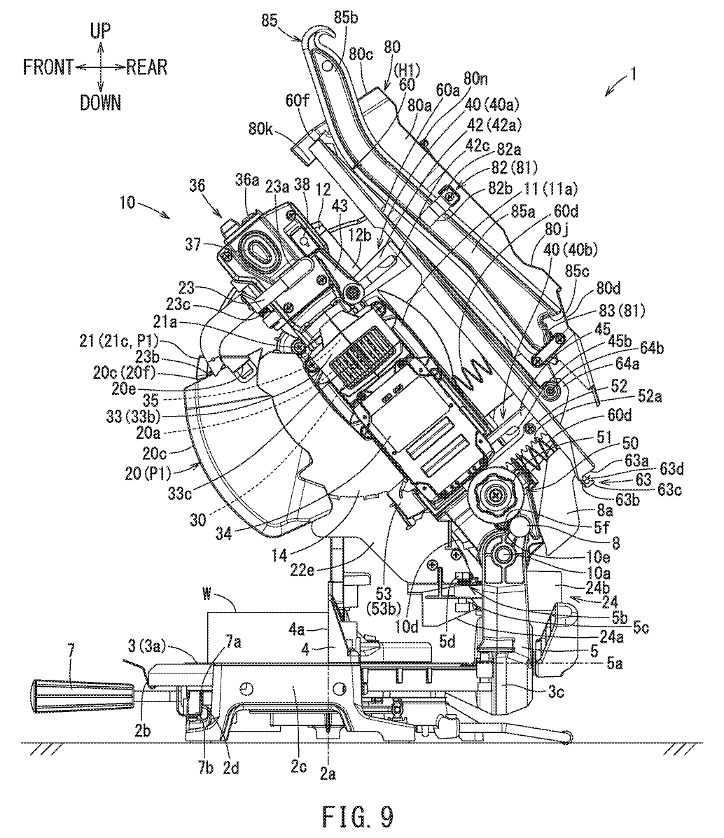

The tabletop miter saw 1 according to the present disclosure may be used by switching between a tabletop miter saw mode and a table saw mode. In the tabletop miter saw mode, the workpiece W placed on the upper surface 3a of the turntable 3 is cut as shown in FIG. 2. In this mode, the cutting tool unit 10 is pivoted downward with the upper table 60 raised to its uppermost lifted position so that the lower portion of the saw blade 14 cuts into the workpiece W placed on the upper surface 3a of the turntable 3. In the table saw mode, as shown in FIG. 9, the workpiece W placed on the upper surface 60a of the upper table 60 is cut. Specifically, with the cutting tool unit 10 locked at the bottom dead center, the workpiece W is cut by feeding the workpiece W from the front to the rear toward the upper portion of the saw blade 14 protruding upward from the upper surface 60a of the upper table 60.

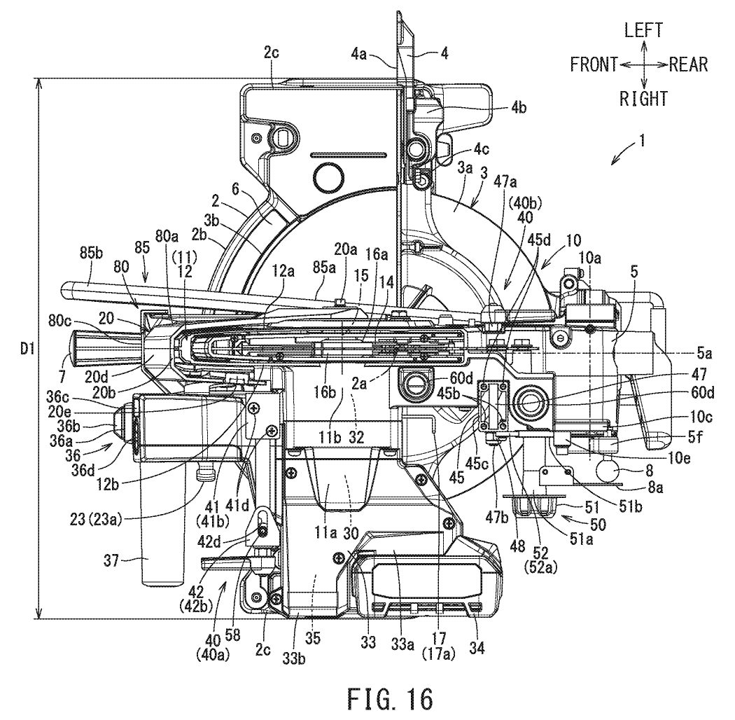

As shown in FIGS. 1 and 16, the upper surface 3a of the turntable 3 has a substantially circular shape in plan view and extends horizontally. A table turning spindle 2a is located at the center of the substantially circular shape of the turntable 3. The turntable 3 is horizontally rotatable around the table turning spindle 2a, which extends in the up-down direction. The base 2 has an auxiliary table 2c with the same upper surface height as the upper surface 3a on both the left and right sides of the turntable 3. The upper surface of the turntable 3 is provided with a table insert 3d secured by screws. As shown in FIG. 2, a notched groove slot 3e extending in the front-rear direction along the side of the saw blade 14 is formed at the center of the blade table insert 3d. When the cutting tool unit 10 is lowered near the bottom dead center, the lower portion of the saw blade 14 enters the groove slot 3e.

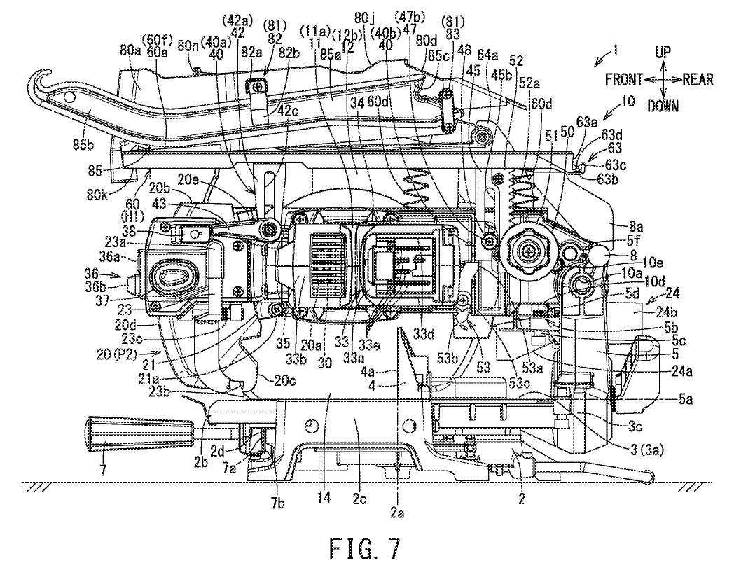

As shown in FIG. 1, a wall-shaped alignment fence 4 extending in the left-right direction and extending upwardly is provided above the turntable 3 and the auxiliary table 2c. The alignment fence 4 is supported by the left and right auxiliary tables 2c via fence fixing bolts (rotation shaft) 4c. As shown in FIG. 7, the alignment face 4a, which is the front surface of the alignment fence 4, is located on a vertical plane passing through the table turning spindle 2a, which is the center of rotation of the turntable 3. The workpiece placed on the turntable 3 is positioned in the front-rear direction by abutting the alignment face 4a.

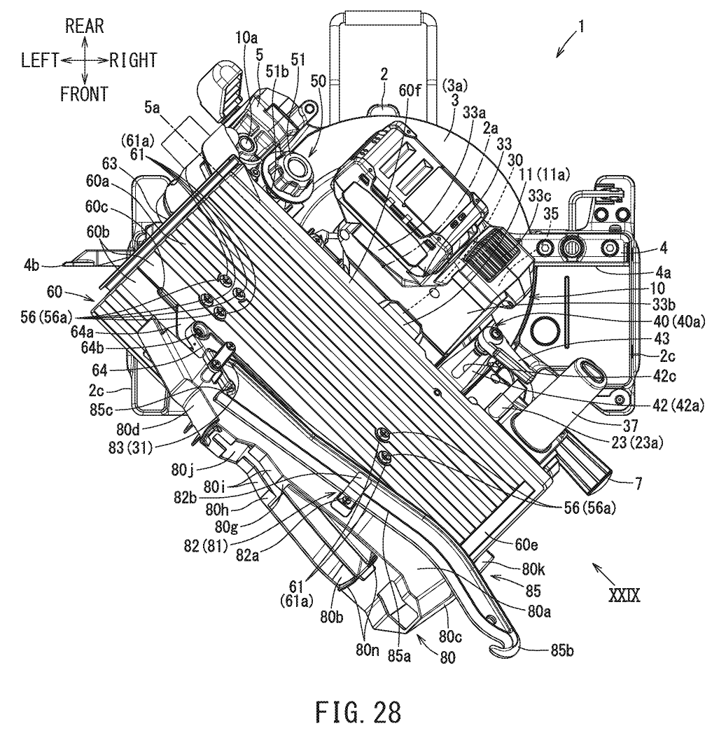

As shown in FIGS. 1 and 16, an arc-shaped miter scale plate 6 extending in the horizontal direction is provided in a substantially semicircular region at the front portion of the base 2. The miter scale plate 6 indicates the horizontal rotation angle (miter angle) of the turntable 3. The miter angle is defined as an angle between the side of the saw blade 14 and the imaginary plane orthogonal to the alignment face 4a of the alignment fence 4. When the miter angle is 0 degrees, the workpiece can be cut at a right angle to the longitudinal direction of the workpiece. As shown in FIG. 28, by rotating the turntable 3 to either the left or right, the saw blade 14 can be set at an oblique posture with respect to the imaginary plane orthogonal to the alignment face 4a of the alignment fence 4. Cutting the workpiece in this posture in the tabletop miter saw mode is referred to as a “miter cut.”

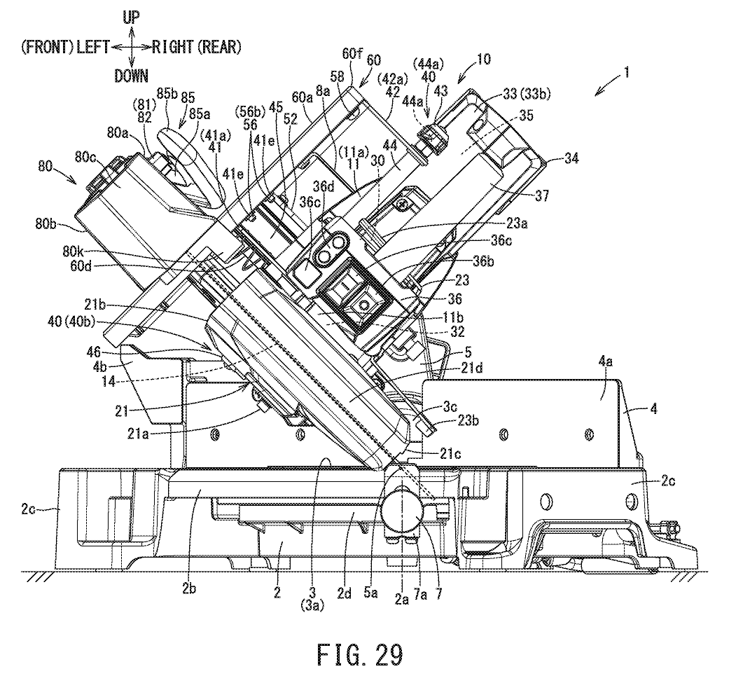

As shown in FIGS. 1 and 7, an arm supporter 3c is provided at the rear of the turntable 3. Behind the arm supporter 3c, an upwardly extending supporting arm 5 is provided. The supporting arm 5 is supported by the arm supporter 3c so as to be tiltable in the left-right direction about a left-right tilt support shaft 5a extending in the front-rear direction. As shown in FIG. 29, by tilting the saw blade 14 to the left and right in the tabletop miter saw mode, a so-called bevel cut can be performed on the workpiece placed on the turntable 3. The angle of the bevel cut is indicated by a pointer and scale on the rear of the unit.

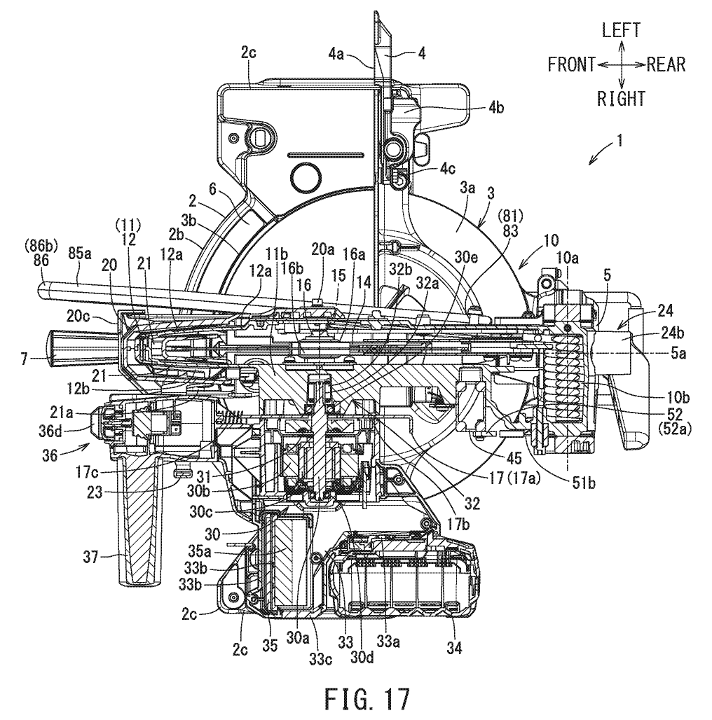

As shown in FIGS. 7 and 9, the rear portion of the cutting tool unit 10 is connected to the supporting arm 5 via an up-down pivot shaft 10a extending in the left-right direction. The cutting tool unit 10 is pivotable in the up-down direction around the up-down pivot shaft 10a in the tabletop miter saw mode. As shown in FIG. 17, a torsion spring 10b is provided around the up-down pivot shaft 10a and biases the cutting tool unit 10 upward toward the top dead center.

As shown in FIG. 7, a bottom dead center stopper 5b is provided on the supporting arm 5. The bottom dead center stopper 5b is provided forward and below the up-down pivot shaft 10a. The bottom dead center stopper 5b includes a hexagon socket bolt 5c, a hexagon nut 5d, and a compression spring 5e. The hexagon socket bolt 5c is threaded to the supporting arm 5 and projects its tip end upward. An adhesive is applied to the threaded portion of the hexagon socket bolt 5c to prevent it from falling off the supporting arm 5 due to vibration or the like. A bottom dead center stopper contact point 10d is provided on the rear lower surface of the cutting tool unit 10. When the bottom dead center stopper contact point 10d contacts the tip end of the hexagon socket bolt 5c, the downward swing of the cutting tool unit 10 stops at the bottom dead center. The upward protrusion length of the hexagon socket bolt 5c can be changed by, for example, inserting a hexagonal wrench into the hexagonal hole in the head and rotating it. This allows fine adjustment of the position of the bottom dead center of the cutting tool unit 10. When the user stops applying downward load to the cutting tool unit 10, the cutting tool unit 10 moves slightly upward. This play reduces the stability of the upper table 60 in the table saw mode. Therefore, in the table saw mode, the play can be suppressed by adjusting the hexagon nut 5d to move upward to eliminate the clearance with the bottom dead center stopper contact point 10d. The compression spring 5e biases the hexagon nut 5d upward, thereby preventing the hexagon nut 5d from falling off.

As shown in FIG. 9, a top dead center stopper 10e is provided at the rear of the cutting tool unit 10. The top dead center stopper 10e is cylindrical and protrudes to the right from the cutting tool unit 10. A top dead center stopper contact point 5f is provided on the supporting arm 5. The top dead center stopper contact point 5f is provided above the up-down pivot shaft 10a. When the top dead center stopper 10e contacts the top dead center stopper contact member 5f, the upward swing of the cutting tool unit 10 stops at the top dead center.

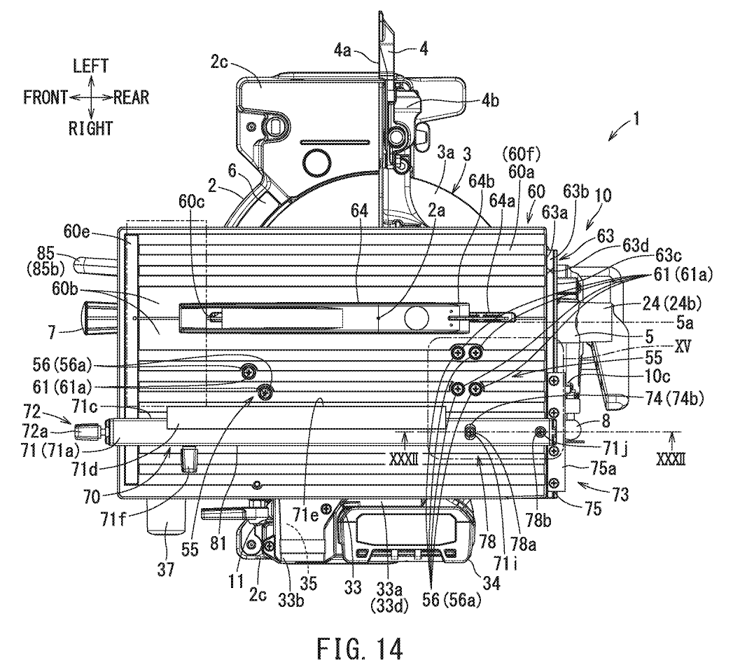

As shown in FIGS. 9 and 14, a lock pin 8 is provided in the upper portion of the supporting arm 5. The lock pin 8 is slidable in the left-right direction and has a knob at its end for manual operation. An engagement recess 10c is provided on the upper surface of the rear end of the cutting tool unit 10 to allow the locking pin 8 to enter. When the cutting tool unit 10 is at the bottom dead center, the locking pin 8 can be slid to the left to engage the engagement recess 10c. This allows the cutting tool unit 10 to be locked at the bottom dead center. When the cutting tool unit 10 is positioned above the bottom dead center, the engagement recess 10c is located above the travel path of the locking pin 8. Therefore, the locking pin 8 cannot enter the engagement recess 10c.

As shown in FIG. 14, a restriction plate 8a is provided at the rear lower portion of the upper table 60. The restriction plate 8a extends downward from the lower surface of the upper table 60. The restriction plate 8a is located at a position to the right side of the locking pin 8 when the cutting tool unit 10 is at its bottom dead center. As shown in FIG. 2, when the upper table 60 is in a lower position than the uppermost lifted position, the restriction plate 8a is aligned to the left and right in the same upper/lower position as the locking pin 8. Therefore, the locking pin 8 is restricted from moving to the right and remains engaged with the engagement recess 10c. As a result, the cutting tool unit 10 is maintained locked at the bottom dead center and can be used in the table saw mode. As shown in FIG. 7, when the upper table 60 is raised to its uppermost lifted position, the saw blade 14 does not protrude above the upper surface of the upper table 60. The restriction plate 8a is positioned above the locking pin 8. Therefore, the engagement of the locking pin 8 and the engagement recess 10c can be disengaged. This allows the cutting tool unit 10 to be used in the tabletop miter saw mode, in which the cutting tool unit 10 is pivoted up and down.

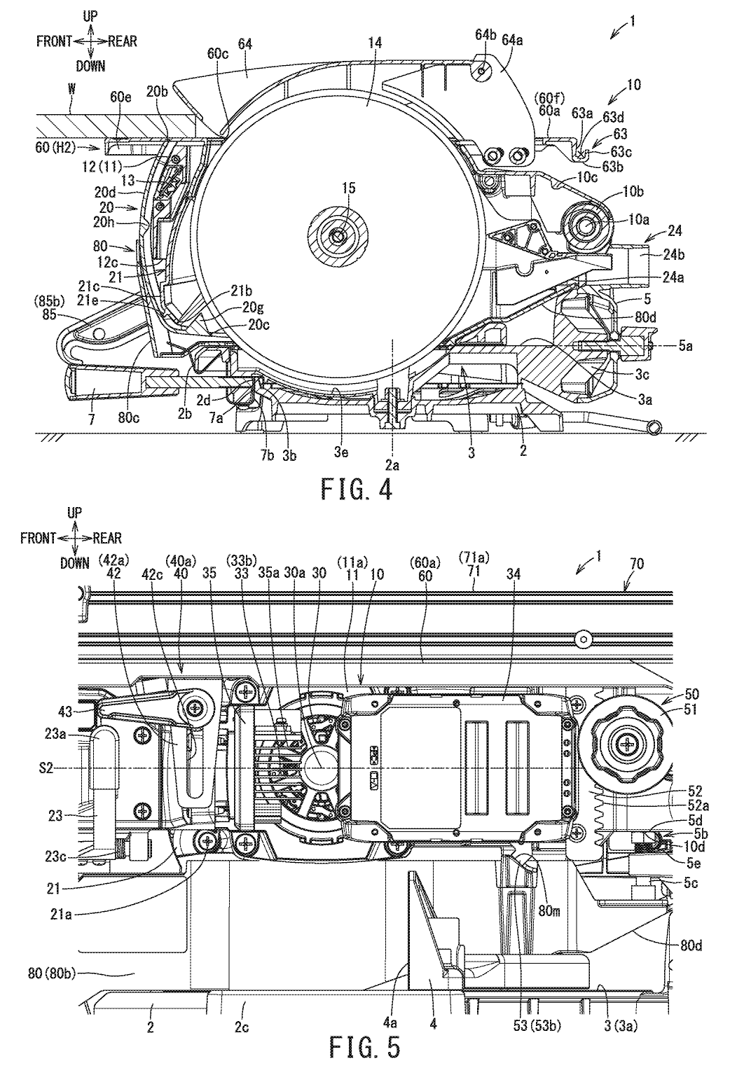

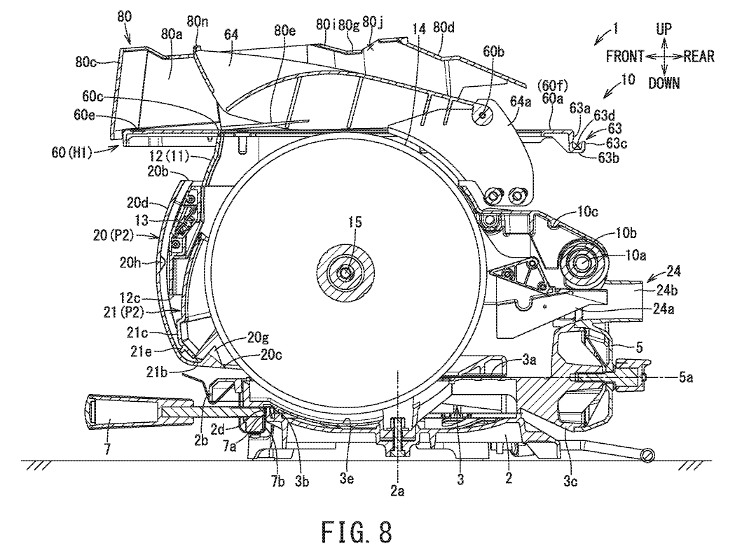

As shown in FIG. 1, the upper table 60 is a horizontal rectangular flat plate with the saw blade 14 oriented in a vertical posture. A workpiece can be placed on the upper surface 60a of the upper table 60 in the table saw mode. A slit-shaped through hole 60c is provided passing through the upper table 60 in the up-down direction. The through hole 60c extends straight in the front-rear direction. A table insert 60b is provided on the upper surface 60a of the upper table 60 to surround the through hole 60c and is secured by countersunk screws. By lifting and lowering the upper table 60 relative to the cutting tool unit 10, the saw blade 14 moves in and out of the through hole 60c. This allows the upward protrusion length of the saw blade 14 from the upper surface 60a of the upper table 60 to be changed. For example, when the upper table 60 is lowered to the lowermost lowered position H2 as shown in FIG. 4, the saw blade 14 protrudes above the upper surface 60a at its maximum protrusion length. When lifting the upper table 60 to its uppermost lifted position H1 as shown in FIG. 8, the upper portion of the saw blade 14 does not extend beyond the upper surface 60a of the upper table 60.

As shown in FIG. 1, a rail 63 is provided on the rear surface of the upper table 60. The rail 63 extends straight in the left-right direction orthogonal to the side of the saw blade 14. The details of rail 63 will be described later. A plate 60e for enhancing slidability is provided at the front end of the upper surface 60a. The upper surface of the plate 60e is flush with the upper surface 60a of the upper table 60. A riving knife 64a for preventing kickback is provided behind the saw blade 14. The riving knife 64a protrudes upward from the upper surface 60a of the upper table 60 through the through hole 60c. In front of the riving knife 64a, an upper cover 64 is provided to cover the upper portion of the saw blade 14. The upper cover 64 rotates in the up-down direction around a rotation support shaft 64b at the upper portion of the riving knife 64a. By feeding the workpiece rearward toward the saw blade 14 on the upper surface 60a of the upper table 60, the upper cover 64 is gradually pushed upward to open.

As shown in FIGS. 3 and 7, an elevating mechanism 50 is provided at the right rear of the cutting tool unit 10. The upper table 60 is lifted and lowered in the up-down direction by operating the elevating mechanism 50. On the lower surface of the upper table 60, front guide members 41, 42 and a rear guide member 45 are mounted as a guide mechanism 40 that guides the table in the up-down direction. The guide mechanism 40 and elevating mechanism 50 will be described in detail later. A compression spring 60d is provided between the lower surface of the upper table 60 and the upper surface of the cutting tool unit 10 to elastically hold the upper table 60.

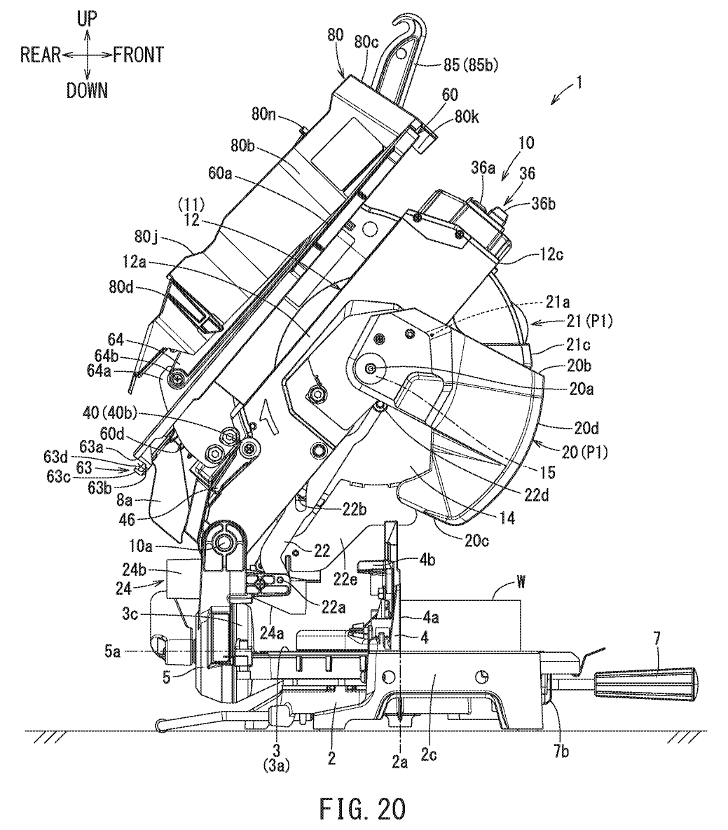

As shown in FIGS. 9 and 20, the cutting tool unit 10 has a fixed cover 12, a movable cover 20, and an auxiliary cover 21 covering the saw blade 14. The fixed cover 12 covers the upper portion of the saw blade 14 from both the left and right sides and from the front and rear sides. The movable cover 20 and the auxiliary cover 21 are supported on the fixed cover 12, which can be opened and closed between open and closed positions, respectively. The movable cover 20 covers the front lower portion of the saw blade 14 in the closed position. The auxiliary cover 21 covers the front middle portion of the saw blade 14 between the fixed cover 12 and the movable cover 20 in the up-down direction direction in the closed position. The movable cover 20 and the auxiliary cover 21 open and close in conjunction with the up-down swing of the cutting tool unit 10 in the tabletop miter saw mode. The movable cover 20 and the auxiliary cover 21 move to the closed position when the cutting tool unit 10 is in the top dead center. The movable cover 20 and the auxiliary cover 21 gradually open as the cutting tool unit 10 is moved downward, and are open to the widest extent when the cutting tool unit 10 is at its bottom dead center (see FIG. 7). The lower portion of the saw blade 14 is exposed when the cutting tool unit 10 is moved downward, thereby allowing the saw blade 14 to cut into the workpiece placed on the turntable 3. The movable cover 20 and the auxiliary cover 21 will be described in detail later.

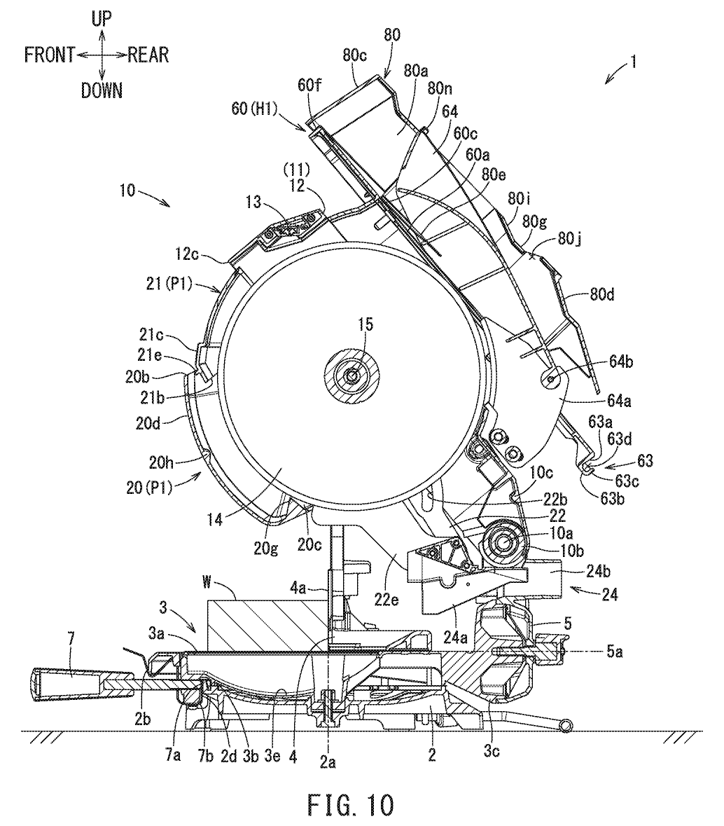

As shown in FIG. 10, an illuminator 13 is provided on the inner circumferential surface of the front portion of the fixed cover 12. The illuminator 13 has a light-emitting member, such as an LED, for example. The illuminator 13 emits light toward the radially inward saw blade 14. When the cutting tool unit 10 is near the top dead center, the light emitted by the illuminator 13 can cast the shadow of the saw blade 14 on the upper surface of the workpiece W placed on the upper surface 3a of the turntable 3. By aligning the marking line drawn on the upper surface of the workpiece W with the shadow of the saw blade 14, the saw blade 14 is allowed to cut into the position of the marking line when the cutting tool unit 10 is swung downward.

As shown in FIGS. 2 and 9, a dust collection guide 24 is provided at the lower rear of the fixed cover 12. The dust collection guide 24 prevents the scattering of dust (cutting chips) generated when the saw blade 14 cuts the workpiece. The dust collection guide 24 includes a guide plate portion 24a behind the saw blade 14 and a dust collection port 24b behind the guide plate portion 24a. The guide plate portion 24a extends in a flat plate shape in the front-rear direction at the left and right sides of the saw blade 14, respectively. The dust collection port 24b is cylindrical and opens at the front and rear ends and is connected to the guide plate portion 24a at the front end. A dust collection hose is connected to the dust collection port 24b and connected to a separately prepared dust collector. This allows dust scattered around the dust collection guide 24 to be sent to a dust collector.

As shown in FIG. 17, the cutting tool main body 10 is provided with an output shaft 15 that extends in the left-right direction and is rotatably supported about its axis. The saw blade 14 rotates integrally with the output shaft 15. The saw blade 14 is attached to the output shaft 15 by tightening the lock screw 16, with the center of rotation held between the outer flange 16a and inner flange 16b from both the left and right sides.

As shown in FIGS. 16 and 17, the cutting tool unit 10 has a main body housing 11 integrated with the fixed cover 12. The main body housing 11 includes a gear housing 11b located to the right of the saw blade 14 and a motor housing 11a located further to the right of the gear housing 11b. Further to the right of the motor housing 11a a battery attachment portion 33 is provided to which a battery 34 is detachably attached. The motor housing 11a houses a motor 30, referred to as a DC brushless motor. The gear housing 11b houses a power transmission section 32 consisting of a reduction gear that transmits the output of the motor shaft 30a of the motor 30 to the output shaft.

As shown in FIG. 17, the motor shaft 30a extends in a left-right direction orthogonal to the sides of the saw blade 14 and parallel to the upper table 60. The motor shaft 30a is supported by bearings 30d, 30e and rotates about its axis. A stator 30b of the motor 30 is non-rotatably supported on the inner circumferential surface of the motor housing 11a. A rotor 30c of the motor 30 is located on the inner circumferential side of the stator 30b. The rotor 30c is mounted on the motor shaft 30a and integrally rotates with motor shaft 30a about its axis. An air intake port 33c, through which outside air can be taken in, is provided on the rightward extension of the motor shaft 30a and on the right side of the battery attachment portion 33. A fan 31 is mounted on the left part of the motor shaft 30a and to the left of the left side bearing 30e. The fan 31 integrally rotates with the motor shaft 30a about its axis. When the motor 30 is started and the fan 31 rotates, cooling air is introduced from the air intake port 33c into the battery attachment portion 33 and further into the left motor housing 11a. The introduced cooling air cools the motor 30 and the controller 35 described below.

As shown in FIG. 17, a drive-side spur gear 32a is integrally attached to the left end of the motor shaft 30a. The drive-side spur gear 32a is housed in the gear housing 11b. A driven-side spur gear 32b is attached to the right part of the output shaft 15. The drive-side spur gear 32a and the driven-side spur gear 32b mesh with each other. As a result, the rotational power of the motor shaft 30a is transmitted to the output shaft 15 at a reduced speed.

As shown in FIG. 17, an operation portion 17a of a shaft lock 17 is provided at the rear of the motor housing 11a. The shaft lock 17 is inserted into the motor housing 11a at the front. The front end of the shaft lock 17 is biased toward the rear via a compression spring 17c. When the operation portion 17a of the shaft lock 17 is pushed forward against the biasing force, the engaging portion 17b of the shaft lock 17 engages the motor shaft 30a. This restricts the rotation of the motor shaft 30a t, and the axial rotation of the output shaft 15. As a result, the process of attaching or removing the saw blade 14 to or from the output shaft 15 can be performed easily.

As shown in FIG. 17, the battery attachment portion 33 includes a controller housing section 33b at the front and a connection terminal housing section 33a at the rear. The connection terminal housing section 33a is plate-shaped, elongated in the front-rear direction and faces to the right, which is the direction opposite to the saw blade 14. The controller housing section 33b is plate shape, elongated in the left-right direction and faces rearward where the connection terminal housing section 33a is located. In other words, the battery attachment portion 33 to which the connection terminal housing section 33a and the controller housing section 33b are connected is L-shaped when viewed from above. The attachment surface of the connection terminal housing section 33a faces to the right, which is the side opposite to the saw blade 14.

As shown in FIG. 3, the connection terminal housing section 33a is provided with a rail 33d and a connection terminal 33e. The rail 33d extends in the front-rear direction along the longitudinal direction of the connection terminal housing section 33a on both the upper and lower sides of the connection terminal housing section 33a. The connection terminal 33e projects from the connection terminal housing section 33a toward the right opposite the saw blade 14 and extends substantially parallel to the rail 33d in the front-rear direction. The connection terminal housing section 33a allows the battery 34 (see FIG. 2) to slide in the front-rear direction along the rail 33d so as to be attached or removed. As shown in FIG. 14, the right portion of the connection terminal housing section 33a is exposed to the right from the upper table 60 when viewed from above.

As shown in FIGS. 2 and 14, the battery 34 has a substantially rectangular box shape, being longest in the front-rear direction, and next longest in the up-down direction, when mounted in the battery attachment portion 33. The battery 34 can be attached by sliding it from the rear to the front against the connection terminal housing section 33a of the battery attachment portion 33. The battery 34 can be removed by sliding it from the front to the rear against the connection terminal housing section 33a. A release button is provided on the battery 34 to facilitate this removal. A space is provided behind the connection terminal housing section 33a to prevent the sliding battery 34 from interfering with other parts. The battery 34 may be, for example, a lithium-ion battery with an output voltage of 40 V. The battery 34 can be removed from the battery attachment portion 33 and repeatedly recharged using a separately prepared charger. The battery 34 may also be used as a power source interchangeably with other rechargeable electric power tools such as screwdrivers and electric drills.

As shown in FIG. 2, the battery 34 attached to the battery attachment portion 33 is positioned entirely below the imaginary plane S1 at the same level as the upper surface 60a when the cutting tool unit 10 is at its bottom dead center and the upper table 60 is at its lowermost lowered position H2. The upper surface 60a in this state is the uppermost end 60f of the upper table 60. Similarly, as shown in FIG. 7, when the cutting tool unit 10 is at the bottom dead center and the upper table 60 is at the uppermost lifted position H1, the entire battery 34 is positioned below the upper surface 60a. Similarly, as shown in FIG. 9, when the cutting tool unit 10 is at the top dead center, the entire battery 34 is positioned below the front end of the upper surface 60a, which is the uppermost end 60f of the upper table 60. As shown in FIG. 14, the battery 34 is exposed to the right of the upper table 60 when viewed from above. The distance between the left end face of the auxiliary table 2c on the left side and the right end face of the auxiliary table 2c on the right side in the direction of the thickness of the saw blade 14 in the perpendicular state is determined as the longest diameter D1 of the base 2. The entire battery 34 attached to the battery attachment portion 33 is disposed so as to be fitted within the range of the longest diameter D1.

As shown in FIG. 17, a controller 35 is housed within the controller housing section 33b. The controller 35 has a shallow substantially rectangular parallelepiped case and a control board that is housed in the case and resin-molded. The control board of the controller 35 contains a control circuit with a microcontroller that transmits control signals to the motor 30 and a drive circuit with FETs that switch the current of the motor 30 based on signals received from the control circuit. The control board is also equipped with an auto-stop circuit that shuts off the power supply to the motor 30 to prevent over-discharge or over-current conditions according to the detection results of the state of the battery 34. The controller 35 is housed in the front part of the controller housing section 33b in an orientation that is longest in the left-right direction substantially parallel to the motor shaft 30a, and next longest in the front-rear direction.

As shown in FIG. 5, the controller 35 and the battery 34 are disposed so as to pass through the imaginary plane S2 at the same up-down level as the motor shaft 30a. The controller 35 is positioned forward of the motor shaft 30a. The battery 34 is positioned rearward of the motor shaft 30a. A plate-shaped heat sink 35a is provided extending rearwardly from the controller 35. The heat sink 35a is composed of a plurality of plates extending substantially horizontal and aligned in the up-down direction. As shown in FIG. 17, the heat sink 35a is disposed on the airflow path of the cooling air from the air intake port 33c on the right side of the battery attachment portion 33 to the fan 31. Therefore, the controller 35 can be efficiently cooled via the heat sink 35a.

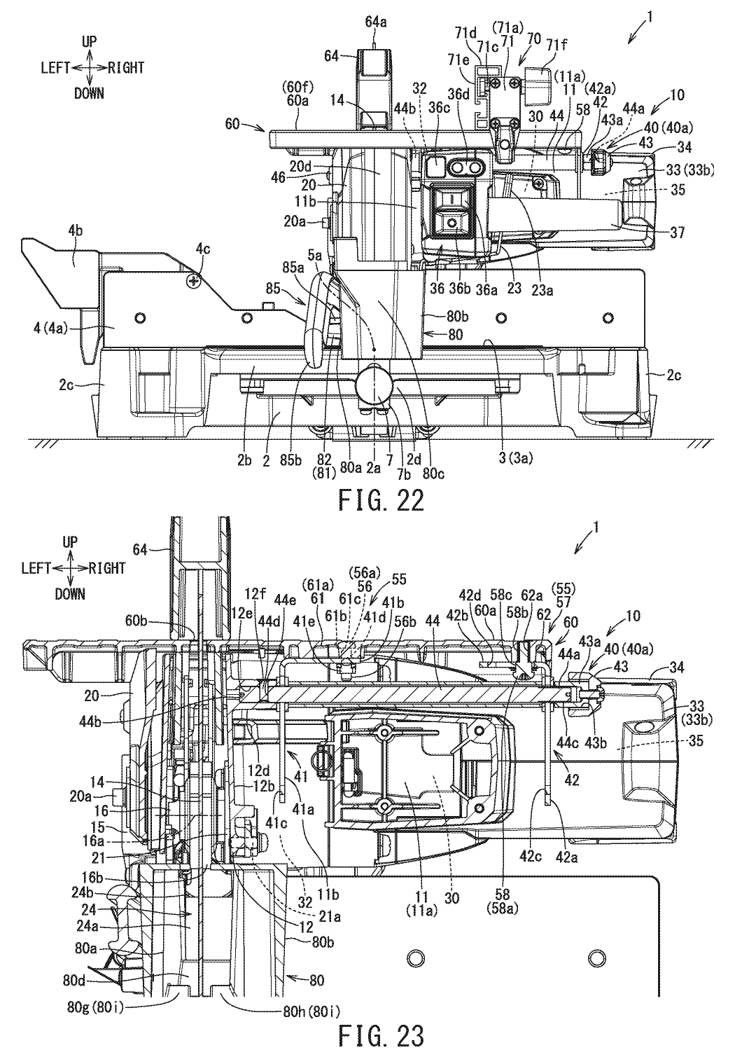

As shown in FIG. 22, a switch section 36 is provided in front of the motor housing 11a and gear housing 11b. A handle 37 extends from the switch section 36 toward the right opposite the saw blade 14. The user pivots the cutting tool unit 10 up and down while grasping the handle 37. The front of the switch section 36 is provided with an ON button 36a to start the motor 30, an OFF button 36b to stop the motor 30 from starting, an illuminator button 36c to turn ON/OFF the illuminator 13 for marking line alignment, and a dust collector start button 36d to turn ON/OFF a separately provided dust collector. As shown in FIG. 2, a communication adapter 38 can be inserted and attached to the right side of the switch section 36. The communication adapter 38 is capable of wireless communication with other auxiliary equipment, such as, for example, a dust collector that may be installed separately from the tabletop miter saw 1. Through wireless communication, the tabletop miter saw 1 and the auxiliary equipment may be linked for startup and shutdown operations.

As shown in FIG. 9, a cover lock lever 23 is provided below the switch section 36. An operation portion 23a is provided at the right end of the cover lock lever 23. The left end of the cover lock lever 23 is provided with an engaging portion 23b that is engageable with the movable cover 20. The cover lock lever 23 is rotatably connected to the lower surface of the switch portion 36 in a left-right direction at the intermediate position between the operation portion 23a and the engaging portion 23b in the left-right direction. The cover lock lever 23 is biased by the torsion spring 23c such that the engaging portion 23b moves away from the movable cover 20 to the right. By pushing the operation portion 23a downward, the engaging portion 23b moves closer to the left with respect to the movable cover 20. This allows the movable cover 20 to be held in the closed position P1.

As shown in FIGS. 1, 2 and 4 the front of the turntable 3 is provided with a miter angle locking grip 7. A tip end pressing portion 7a of the miter angle locking grip 7 faces a front circumferential wall 2d of the base 2 via a leaf spring 7b. By rotating the miter angle locking grip 7 about its axis in the loosening direction, the pressing portion 7a moves away from the front circumferential wall 2d. This allows the user to grasp the miter angle locking grip 7 and rotate the turntable 3 around the table turning spindle 2a. By rotating the miter angle locking grip 7 about its axis in the tightening direction, the pressing portion 7a approaches the front circumferential wall 2d. The pressing force of the pressing portion 7a causes the base 2 and the turntable 3 to resiliently press against each other in the radial direction of the turntable 3. This allows the turntable 3 to be positioned at any desired miter angle relative to the base 2.

As shown in FIGS. 1 and 14, a rip fence 70 may be removably mounted on the upper surface 60a of the upper table 60. The rip fence 70 is fixed to the upper table 60 with the fence body 71 extended in the front-rear direction parallel to the saw blade 14. The workpiece is placed on the upper surface 60a of the upper table 60 and fed from the front to the rear of the saw blade 14 while being pressed against a material contact face 71e. This allows the saw blade 14 to cut the workpiece straight. The rip fence 70 will be described in detail later.

As shown in FIG. 1 and 14, when using in table saw mode, the blade cover 80 is placed on the upper surface 3a of the turntable 3. The blade cover 80 covers the lower part of the saw blade 14 that is exposed below the fixed cover 12. The blade cover 80 also serves as a dust collection cover to prevent the scattering of dust around the saw blade 14. A push stick for pushing the workpiece W rearward along the upper surface 60a of the upper table 60 may be removably attached to the blade cover 80. As shown in FIG. 7, when using in the tabletop miter saw mode, the blade cover 80 may be removed from the upper surface 3a of the turntable 3 and placed on the upper table 60. The blade cover 80 and the push stick 85 will be described in detail later.

### Guide Mechanism 40

As shown in FIG. 16, the guide mechanism 40 has a front guide mechanism 40a and a rear guide mechanism 40b. The front guide mechanism 40a is located to the right of the fixed cover 12 and in front of the motor housing 11a and the gear housing 11b. The front guide mechanism 40a has a fixed guide member 41 on the left and a movable guide member 42 on the right as front guide members. A front locking operation member 43 of the front guide mechanism 40a is provided to the right of the movable guide member 42 and in front of the controller housing section 33b. The rear guide mechanism 40b is provided behind the saw blade 14. The rear guide mechanism 40b has a rectangular cylindrical rear guide member 45. The rear locking operation member 46 of the rear guide mechanism 40b is provided at the left side of the rear of the fixed cover 12. Thus, the front locking operation member 43 and the rear locking operation member 46 are disposed on the right and left sides of the fixed cover 12, respectively.

As shown in FIG. 23, the fixed guide member 41 and the movable guide member 42 each have an L-shaped plate shape as viewed from the front. The fixed guide member 41 has an upright portion 41a that rises I the up-down direction and a horizontal portion 41b that extends substantially orthogonal from the upper end of the upright portion 41a to the right. The movable guide member 42 has an upright portion 42a that rises in the up-down direction and a horizontal portion 42b that extends substantially orthogonal from the upper end of the upright portion 42a to the left. The upright portion 41a of the fixed guide member 41 is provided with a guide hole 41c passing through in the left-right direction and elongated in the front-rear direction. The movable portion 42a of the movable guide member 42 is provided with a guide hole 42c passing through in the left-right direction and elongated in the front-rear direction. A rod 44 connected to the front locking operation member 43 is inserted into the guide holes 41cand 42c.

As shown in FIG. 16, two female threads 41e penetrating in the front-rear direction are provided in the horizontal portion 41b of the locking guide member 41. The female threads 41e are tightened to the screw members 56 (see FIG. 14) of the connecting mechanism 55 to be described later. In the horizontal portion 42b of the movable guide member 42, a fixing-restriction hole 42d penetrating in the front-rear direction and elongated in the left-right direction is provided. As shown in FIG. 23, a leg 58b and a stepped portion 58c of the shoulder screw 58 may be inserted into the fixing-restriction hole 42d, while the head 58a of the shoulder screw 58 cannot be inserted. The stepped portion 58c of the shoulder screw 58 has a larger diameter than the leg 58b and adjacent to the head 58a. A cylindrical boss 62 is provided on the lower surface of the upper table 60, extending in the front-rear direction. The boss 62 is provided with a female thread 62a. To the female thread 62a is tightened a leg 58b of a shoulder screw 58 that is inserted into the fixing-restriction hole 42d of the movable guide member 42.

As shown in FIG. 14, the upper table 60 is provided with a plurality of through holes 61 that penetrate in the up-down direction. A total of six through holes 61 are provided, two on the front guide mechanism 40a side and four on the rear guide mechanism 40b side. The through holes 61 are substantially circular in shape when viewed from above. A screw member 56, referred to as a pan head screw, for example, is inserted into the through hole 61. The upper portion of the through holes 61 is circumferentially surrounded by a hole wall 61a. A clearance is provided horizontally between the hole wall 61a and the head 56a of the screw member 56.

As shown in FIG. 23, a substantially horizontal stepped surface 61b is provided at the center of the through hole 61 in the up-down direction. The through hole 61 is a leg insertion hole 61c with a smaller diameter below the stepped surface 61b. The leg insertion hole 61c is provided with a diameter that allows insertion of the leg 56b of the screw member 56 and does not allow insertion of the head 56a. A clearance is provided horizontally between the leg insertion hole 61c and the leg 56b. The clearance between the hole wall 61a and the head 56a and the clearance between the leg insertion hole 61c and the leg 56b can be used for adjusting the horizontal position of the screw member 56 with respect to the through hole 61. By tightening the leg 56b to the female thread 41e of the fixed guide member 41 after adjusting the position of the screw member 56, the upper table 60 and the fixed guide member 41 can be precisely positioned and connected.

As shown in FIG. 23, the shoulder screw 58 is inserted into the fixing-restriction hole 42d of the movable guide member 42 from below to above. The leg 58b of the shoulder screw 58 is tightened to the female thread 62a of the upper table 60. This constitutes the guide member connecting mechanism 57 that connects the upper table 60 and the movable guide member 42 in a relative movable manner. In other words, in the guide member connecting mechanism 57, the upper table 60 and the movable guide member 42 are connected vertically while the stepped portion 58c of the shoulder screw 58 can slide in the longitudinal direction of the fixing-restriction hole 42d. Therefore, even if, for example, there are variations in the perpendicularity between the upright portion 41a and the horizontal part 41b of the fixed guide member 41 and between the upright portion 42a and the horizontal part 42b of the movable guide member 42, the stepped portion 58c can move within the fixing-restriction hole 42d to absorb the variations in forming accuracy. Therefore, each of the guide hole 41c of the fixed guide member 41 and the guide hole 42c of the movable guide member 42 can slide smoothly in the up-down direction with respect to the rod 44.

As shown in FIG. 23, the right side 12b of the fixed cover 12 is provided with a cylindrical boss 12d projecting to the right. The boss 12d is provided with a front rod hole 12e extending from the right end toward the left and a pin hole 12f that is substantially orthogonal to and connected to the front rod hole 12e. The second end 44b on the left side of the rod 44 is inserted into the front rod hole 12e. A pin is inserted into the second end 44b of the rod 44 and the pin hole 12f as the rotation restriction portion 44d. As a result, the rod 44 is restricted from axial rotation with respect to the front rod hole 12e.

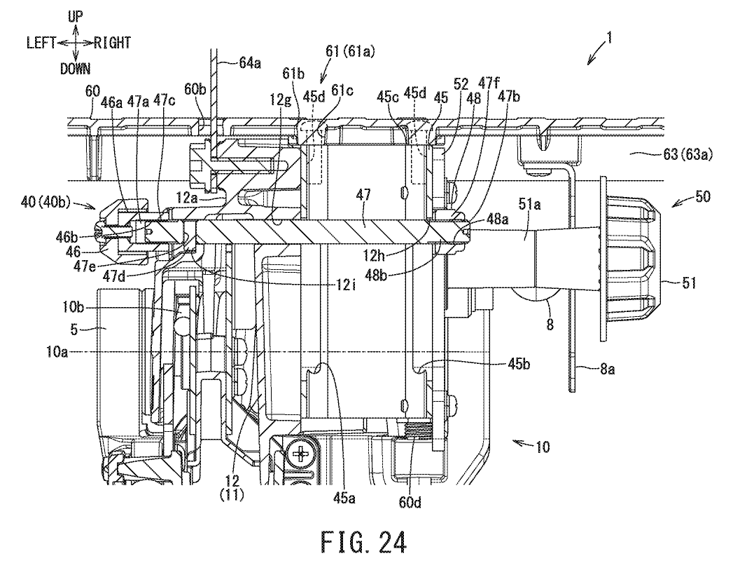

As shown in FIG. 23, a male thread 44c is provided at the right side first end 44a of the rod 44. A nut 43a with a female thread 43b is integrally provided on the lever-shaped front locking operation member 43. The male thread 44c of the rod 44 and the female thread 43b of the front locking operation member 43 are screwed together immediately to the right of the upright portion 42a of the movable guide member 42. When the front locking operation member 43 is axially rotated in the loosening direction, the front locking operation member 43 moves away from the rod 44 to the right. This releases the pressing force in the left-right direction applied to each of the upright portions 41a, 42a of the fixed guide member 41 and movable guide member 42. Therefore, the upper table 60, which is integrated with the fixed guide member 41 and the movable guide member 42, can be lifted and lowered by sliding it in the up-down direction against the fixed cover 12, which is integrated with the rod 44. The upper table 60 is slidably moved in the up-down direction with respect to the fixed cover 12, which is integral with the rod 44 so as to be lifted or lowered. The upper table 60 can be lifted or lowered when both the front locking operation member 43 and the rear locking operation member 46 (see FIG. 24) are axially rotated saft in the loosening direction.

When the front locking operation member 43 is axially rotated in the tightening direction, the front locking operation member 43 moves to the left approaching the rod 44. As a result, the pressing force in the left-right direction is applied to the upright portions 41a, 42a of the fixed guide member 41 and the movable guide member 42, respectively. Therefore, the fixed guide member 41 and the upper table 60, which is integrated with the movable guide member 41, can be positioned at any desired lifted/lowered position with respect to the fixed cover 12, which is integrated with the rod 44.

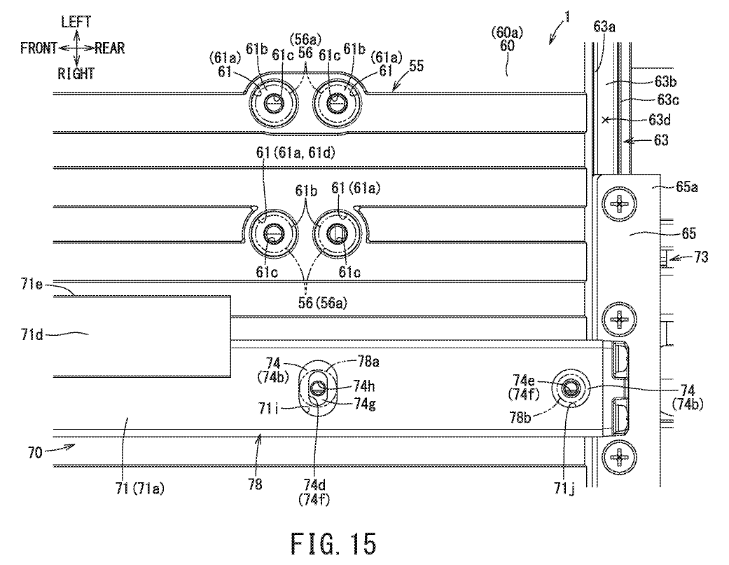

As show in FIG. 16, the rear guide member 45 is positioned to the right of the saw blade 14. The rear guide member 45 is a rectangular cylindrical guide body in a top view having four faces corresponding to rear, front, left and right. The upper surface 45c of the rear guide member 45 is provided with four female threads 45d. The four female threads 45d are provided at the corners where the front, rear, left, and right side faces are substantially orthogonal to each other. A screw member 56 (see FIG. 15) of the connecting mechanism 55 is tightened to the female thread 45d. As shown in FIG. 24, the left side and right side of the rear guide member 45 are provided with a left guide hole 45a and a right guide hole 45b, which pass through in the left and right directions, respectively. The left guide hole 45a and the right guide hole 45b extend parallel to each other and elongated in the front-rear direction. A rod 47 connected to a rear locking operation member 46 is inserted into the left guide hole 45a and the right guide hole 45b.

As shown in FIG. 15, a clearance is provided between the hole wall 61a of the through hole 61 and the head 56a of the screw member 56 in the horizontal direction. One of the through holes located above the rear guide member 45 (see FIG. 16) is a small hole 61d with a smaller diameter than the other holes 61. As shown in FIG. 24, a clearance is provided horizontally between the leg insertion hole 61c and the leg 56b. The clearance between the hole wall 61a and the head 56a and the clearance between the leg insertion hole 61c and the leg 56b can be used to adjusting the horizontal position of the screw member 56 with respect to the through hole 61. This allows the upper table 60 and the rear guide member 45 to be precisely positioned and connected. The screw member 56 inserted through the small through hole 61d have a small clearance for adjusting the horizontal position. When adjusting the position of each screw member 56, the upper table 60 is adjusted by rotating the upper table 60 horizontally around the screw member 56 that is inserted into the small through hole 61d. This facilitates the work of adjusting the position of each screw member 56.

As shown in FIG. 24, the left side 12a of the fixed cover 12 is provided with a rear rod hole 12g that penetrates in the left-right direction and a pin hole 12i that is substantially orthogonal to and connected to the rear rod hole 12g. The first end 47a of the left side of the rod 47 is inserted into the rear rod hole 12g. A pin is inserted into the first end 47a of the rod 47 and the pin hole 12i as a rotation restriction portion 47d. As a result, the rod 47 is restricted in its axial rotation with respect to the rear rod hole 12g. The first end 47a of the rod 47 is provided with a male thread 47c. A nut 46a with a female thread 46b is provided integral to the lever-shaped rear locking operation member 46. The male thread 47c of the rod 47 and the female thread 46b of the rear locking operation member 46 are screwed together immediately to the left of the left side 12a of the fixed cover 12.

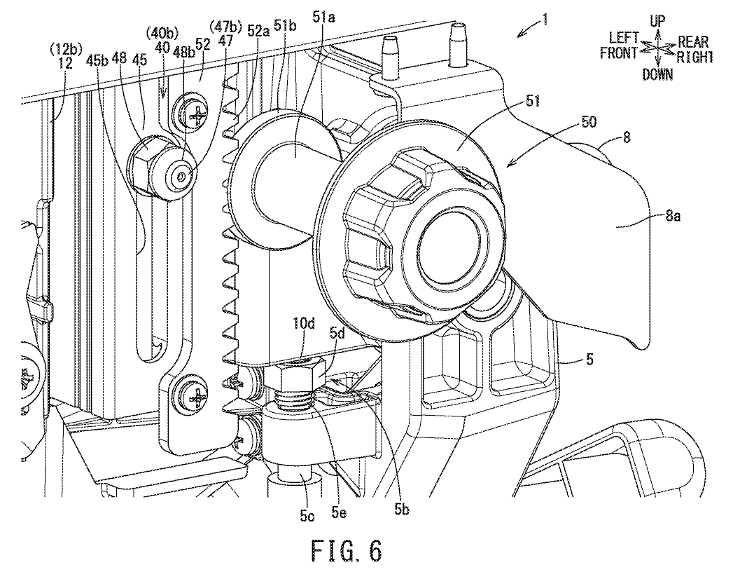

As shown in FIG. 24, the second end 47b of the rod 47 is provided with a male thread 47f. A nut with a female thread 48a as a contact member 48 is screwed onto the male thread 47f. As shown in FIG. 6, the contact member 48 slidably contacts the right side of the rear guide member 45 immediately to the right of the right guide hole 45b.

As shown in FIG. 24, an anti-loosening portion 48b is provided between the female thread 48a of the contact member 48 and the male thread 47f of the rod 47 in the radial direction. The anti-loosening portion 48b may be, for example, a ring made of polyamide (nylon (registered trademark)) or polyamide applied to the male thread 47f or the female thread 48a. By providing the anti-loosening portion 48b , the screwed state between the female thread 48a at the male thread 47f without loosening, and the contact member 48 can be held at any desired tightening position (left-right position) with respect to the second end 47b of the rod 47. By adjusting the tightening position of the contact member 48 with respect to the second end 47b of the rod 47 during product assembly, the clearance between the pressed portion 12h on the right side of the fixed cover 12 and the right side of the rear guide member 45 in the left-right direction can be adjusted to be smaller. This prevents the play between the fixed cover 12 and the rear guide member 45 and enhances the slidability of the rear guide member 45 to slide in the up-down direction.

When the rear locking operation member 46 shown in FIG. 24 is axially rotated in the loosening direction, the rear locking operation member 46 moves away from the rod 47 to the left. As a result, the left-right pressing force between the rear guide member 45 and the pressed portion 12h of the fixed cover 12 is released. Therefore, the upper table 60, which is integrated with the rear guide member 45, can be lifted and lowered by sliding it in the up-down direction with respect to the fixed cover 12, which is integrated with the rod 47. When the rear locking operation member 46 is axially rotated in the tightening direction, the rear locking operation member 46 moves toward the right approaching the rod 47. As a result, the left-right pressing force is applied between the rear guide member 45 and the pressed portion 12h of the fixed cover 12. Therefore, the upper table 60, which is integrated with the rear guide member 45, can be positioned at any desired lifted/lowered position with respect to the fixed cover 12.

As shown in FIG. 3, an elevation stopper 53 is provided in the front lower part of the rear guide member 45. The elevation stopper 53 is supported on the right side 12b of the fixed cover 12 so as to be rotatable in the up-down direction around a rotation shaft 53c. The elevation stopper 53 has a guide contact member 53a at one end and a cover contact member 53b at the other end. The elevation stopper 53 is biased by a torsion spring in the direction (clockwise direction in the figure) in which the guide contact member 53a contacts the lower end of the rear guide member 45. When the blade cover 80 is placed on the upper surface 3a of the turntable 3, the cover contact member 53b is pressed against the stopper contact member 80m on the right side of the blade cover 80. This causes the elevation stopper 53 to rotate in a counterclockwise direction, and the guide contact member 53a is positioned in front of the rear guide member 45. Therefore, the rear guide member 45 can be lifted and lowered without interfering with the elevation stopper 53.

As shown in FIG. 7, when the blade cover 80 is not placed on the upper surface 3a of the turntable 3 and the upper table 60 is in the uppermost lifted position H1, the elevation stopper 53 is rotated in a clockwise direction and the guide contact member 53a contacts the lower end of the rear guide member 45. Therefore, in the tabletop miter saw mode, the upper table 60, which is integrated with the rear guide member 45, can be maintained so as not to be lifted or lowered.

### Elevating Mechanism 50

As shown in FIG. 16, the elevating mechanism 50 is located at the right rear of the cutting tool unit 10. In other words, the elevating mechanism 50 is installed on the same right side as the front locking operation member 43 of the front guide mechanism 40a in the left-right direction, which is the thickness direction of the saw blade 14. The elevating mechanism 50 is provided on the opposite side in the left-rear direction from the rear locking operation member 46 of the rear guide mechanism 40b with the saw blade 14 between them.

As shown in FIG. 6, the elevating mechanism 50 has an axially rotatable knob-shaped elevation operating member 51. The knob 51 features a knurled or indented outer surface for enhanced grip. The elevation operating member 51 is integrally connected with the pinion 51b via the pinion shaft 51a. The elevation operating member 51 and the pinion 51b integrally rotate around the axis of the pinion shaft 51a. The elevating mechanism 50 has a rack plate 52 with a rack 52a. The rack plate 52 is integrally connected to the right side of the rear guide member 45. The rack 52a is provided on the rear side of the rack plate 52 such that the rack teeth are aligned in the up-down direction. The rack 52a and the pinion 51b are meshed with each other. The pinion 51b and the rack 52a are positioned behind the rod 47 of the rear guide mechanism 40b.

As shown in FIGS. 3 and 7, the elevation operating member 51 is axially rotated with the front locking operation member 43 and the rear locking operation member 46 (FIG. 19) both loosened. As the pinion 51b (see FIG. 6) integrated with the elevation operating member 51axially rotates, the rack 52a moves relative to the pinion 51b in the up-down direction. As a result, the rear guide member 45, which are integrated with the rack plate 52 and upper table 60 are lifted and lowered.

### Movable Cover 20

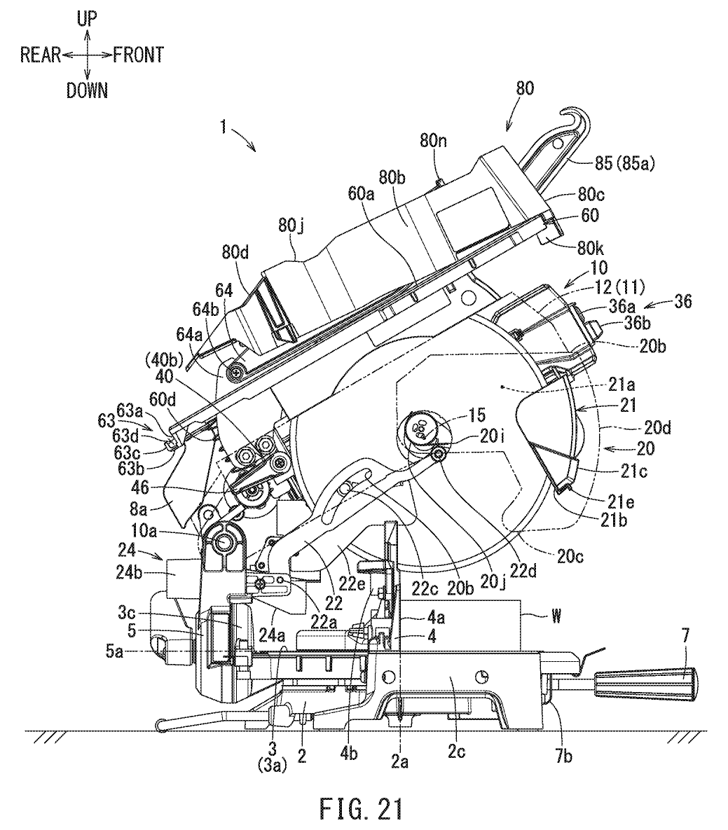

As shown in FIG. 20, the movable cover 20 is rotatably supported by the left side 12a of the fixed cover 12 at the first connecting portion 20a. As shown in FIGS. 19 and 21, the first connecting portion 20a is located slightly above the output shaft 15, which is the rotation center of the saw blade 14. To the left rear of the saw blade 14 is a plate-shaped link arm 22 extending in the front-rear direction. The link arm 22 is rotatably connected to the supporting arm 5 via a rotation shaft 22a at the rear end. In the center of the link arm 22 in the front-rear direction, an arc-shaped long hole 22b that passes through the link arm 22 in the left-right direction is provided. A rear auxiliary cover 22e is integrally fixed with the right rear of the fixed cover 12. The rear auxiliary cover 22e covers the rear part of the saw blade 14. A guide pin 22c protrudes from the rear auxiliary cover 22e to the right and is inserted into the long hole 22b. A contact member 22d is provided at the front end of the link arm 22.

As shown in FIG. 21, a contact piece 20i is provided that is rotatable around the shaft of the first connecting portion 20a. The contact piece 20i is integral with the movable cover 20. The contact member 22d of the link arm 22 is in contact with the lower surface of the contact piece 20i. The movable cover 20, including the contact piece 20i, is biased in the closing direction (clockwise direction in the figure) by the torsion spring 20j. When the cutting tool unit 10 is at the top dead center in the tabletop miter saw mode, the movable cover 20 is biased toward the closed position P1. When the cutting tool unit 10 is pivoted downward, the guide pin 22c moves within the long hole 22b. This causes the contact member 22d of the link arm 22 to move counterclockwise around the shaft of the connecting portion 20a. The contact piece 20i is pushed by the contact member 22d, and the movable cover 20 gradually opens.

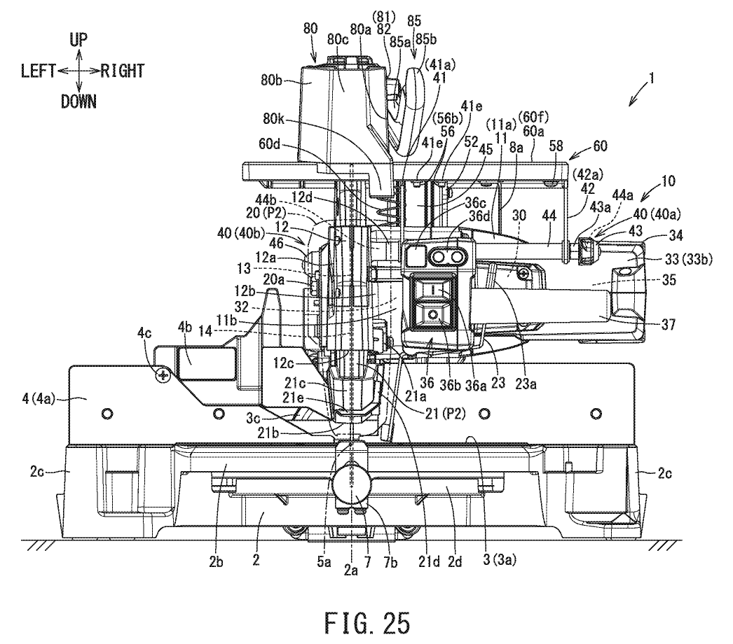

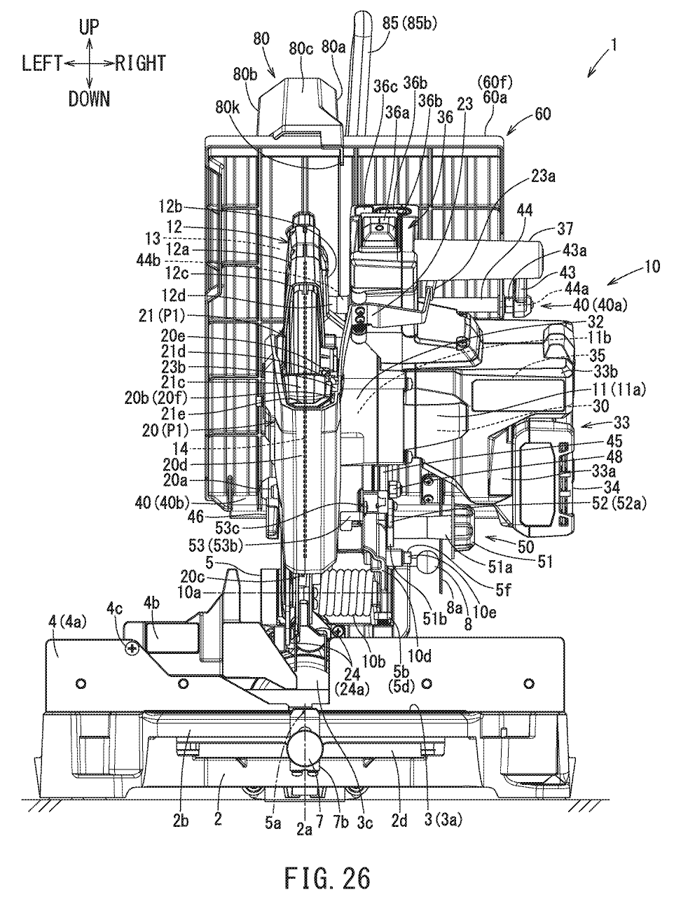

As shown in FIGS. 19 and 25, the movable cover 20 is C-shaped as seen from the circumferential direction to cover the left and right sides and the radially outer side of the saw blade 14. The movable cover 20 covers the radially outer side of the auxiliary cover 21 and the left and right outer sides when in the open position P2. In other words, the auxiliary cover 21 in the open position P2 is housed in the movable cover 20 in the open position P2. The movable cover 20 also covers the front of the fixed cover 12 at the radially outer side and the left and right outer sides in the open position P2. As shown in FIGS. 20 and 26, an opening direction end 20b of the movable cover 20 is located below the front opening 12c of the fixed cover 12 in the closed position P1. The area between the opening direction end 20b and the front opening 12c in the up-down direction is covered by the auxiliary cover 21 in the closed position P1.

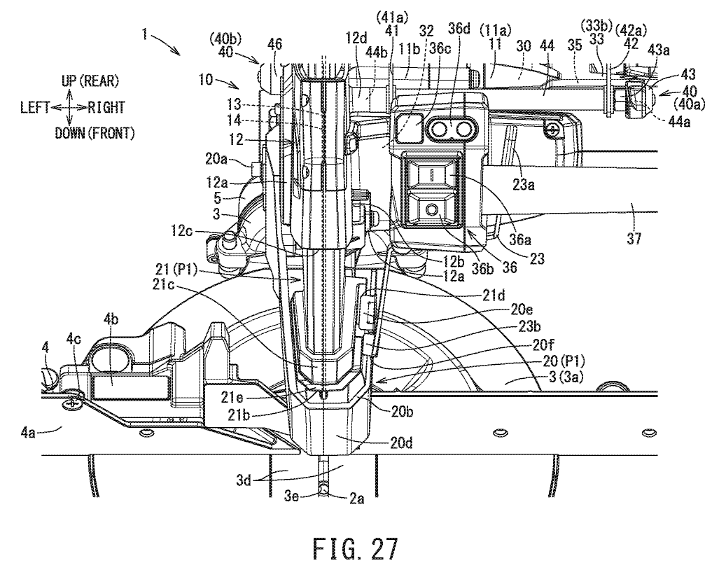

As shown in FIG. 27, a closing linkage portion 20e and a lever linkage engagement portion 20f are provided on the right side of the opening direction end 20b of the movable cover 20. The closing linkage portion 20e is a plate-shaped part made of metal, for example, and its tip end extends to the left toward the inside of the movable cover 20. The closing linkage portion 20e is engageable with an auxiliary closing linkage portion 21d of the auxiliary cover 21 described later. The lever linkage engagement portion 20f is engageable with the engaging portion 23b of the cover lock lever 23 when the cutting tool unit 10 is in the top dead center and the movable cover 20 is in the closed position P1. The engaging portion 23b moved to the left engages the lever linkage engagement portion 20f to hold the movable cover 20 in the closed position P1 to prevent it from opening.

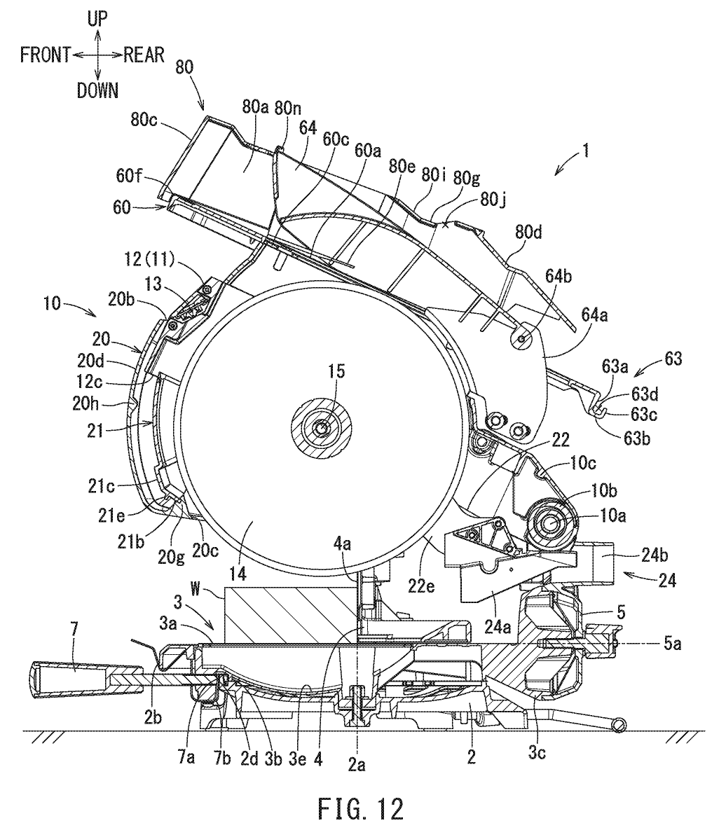

As shown in FIG. 12, an opening linkage portion 20g is provided at opening direction end 20c of the movable cover 20. An opening linkage portion 20g projects radially inward from the outer circumferential wall 20d of the movable cover 20 on the radially outer circumferential side The opening linkage portion 20g is a substantially triangular ridge-like shape as seen from left and right sides. When the movable cover 20 is gradually opened by pivoting the cutting tool unit 10 downward, the opening linkage portion 20g engages the rib (auxiliary opening linkage portion) 21e at the closing direction end 21b of the auxiliary cover 21. As a result, the auxiliary cover 21 gradually opens along with the movable cover 20.

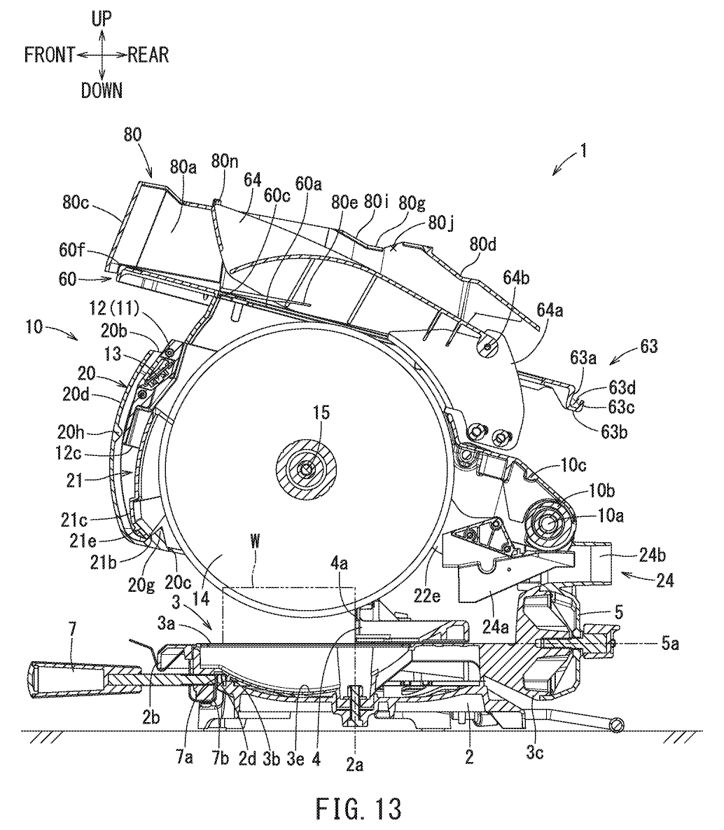

As shown in FIG. 13, a drop projection 20h is provided on the inner circumferential side of movable cover 20. The drop projection 20h projects radially inward from the outer circumferential wall 20d at an intermediate position between the opening direction end 20b and the closing direction end 20c. The drop projection 20h is semi-circular as seen from left and right sides. The drop projection 20h overlaps circumferentially with the rotational path of the outer circumferential wall 21c of the auxiliary cover 21. The drop projection 20h overlaps circumferentially with the outer circumferential wall 21c of the auxiliary cover 21 at least in the open position P2 (see FIG. 8). When the cutting tool unit 10 is pivoted upward, the auxiliary cover 21 may not rotate from the open position P2. Even in this case, the movable cover 20 gradually closes, causing the drop projection 20h to contact the outer circumferential wall 21c of the auxiliary cover 21. As a result, the impact may be applied to the auxiliary cover 21 to move it to the closing position P1 (see FIG. 10).

### Auxiliary Cover 21

As shown in FIG. 20 and 27, the auxiliary cover 21 is C-shaped when viewed from the circumferential direction so as to cover the left and right sides and the radially outer side of the saw blade 14. As shown in FIG. 8, the auxiliary cover 21 is stored in the movable cover 20 in case of the open position P2. The upper part of the auxiliary cover 21 is stored in the fixed cover 12 in case of the open position P2.

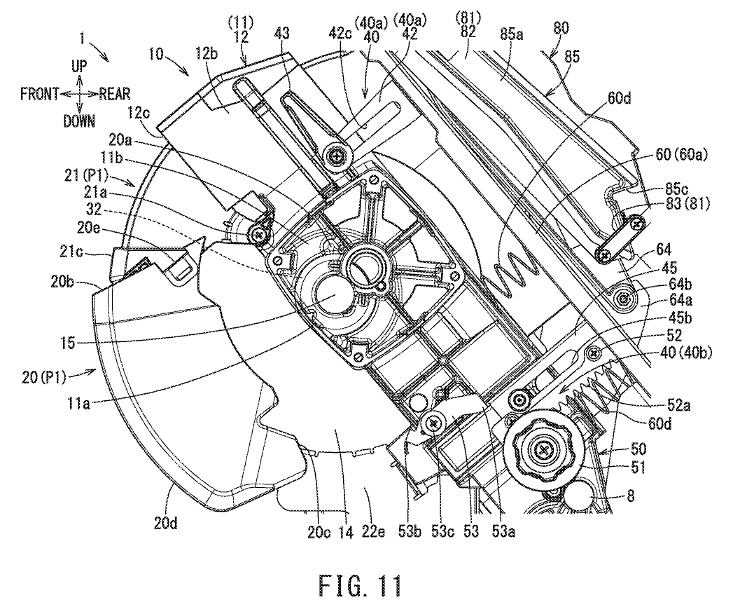

As shown in FIG. 11, the auxiliary cover 21 is rotatably supported to the right side 12b of the fixed cover 12 at the second connecting portion 21a. The second connecting portion 21a is located opposite the first connecting portion 20a in the left-right direction, which is the thickness direction of the saw blade 14. The second connecting portion 21a is positioned forward of the first connecting portion 20a. The second connecting portion 21a is located forward of the gear housing 11b, which houses the power transmission portion 32. Therefore, the rotational radius of the auxiliary cover 21 is shorter than the rotational radius of the movable cover 20.

As shown in FIG. 27, the closing direction end 21b of the auxiliary cover 21 is provided with a rib 21e that extends to left and right outer sides and the radially outer side. The rib 21e reduces the clearance between the closing direction end 21b of the auxiliary cover 21 and the opening direction end 20b of the movable cover 20. The right rear portion of the rib 21e is an auxiliary closing linkage portion 21d that engages the closing linkage portion 20e of movable cover 20 in the closed position P1. The closing linkage portion 20e engages the auxiliary closing linkage portion 21d and pulls it to the closing side. This causes the auxiliary cover 21 to rotate in the closing direction together with the movable cover 20. The radially outer circumference of the rib 21e also serves as an auxiliary opening linkage portion that contacts the drop projection 20h (see FIG. 13).

As shown in FIG. 10, when the cutting tool unit 10 is at the top dead center, the auxiliary cover 21 in the closed position P1 is located below the illuminator 13. As shown in FIG. 8, when the cutting tool unit 10 is at the bottom dead center, the auxiliary cover 21 in the open position P2 enters between the saw blade 14 and the illuminator 13 in the radial direction. Therefore, the auxiliary cover 21 in the open position P2 can prevent the dust generated when cutting the workpiece from hitting the illuminator 13. This allows the brightness of the illuminator 13 to be maintained.

### Mounting Mechanism of Rip Fence 70 and Upper Table 60

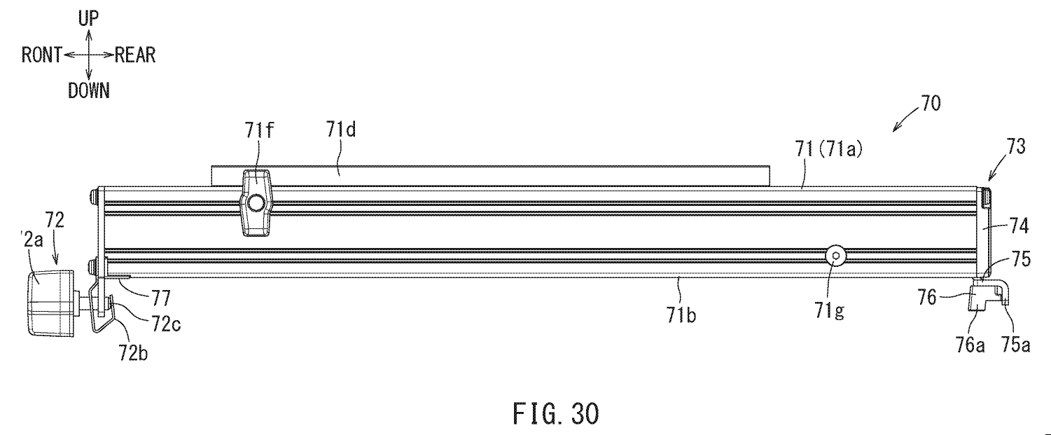

As shown in FIGS. 1 and 30, the rip fence 70 has a fence body 71 that extends long and straight in the front-rear direction. The fence body 71 has a fence base 71a that extends over the front and rear ends of the upper table 60, and a material contact member 71d that is movable in the front-rear direction with respect to the fence base 71a. A pressing portion 72 that engages the front surface of the upper table 60 is provided at the front end of the fence base 71a. At the rear of the fence base 71a, a support member 73 is connected that engages with the rail 63 on the rear surface of the upper table 60.

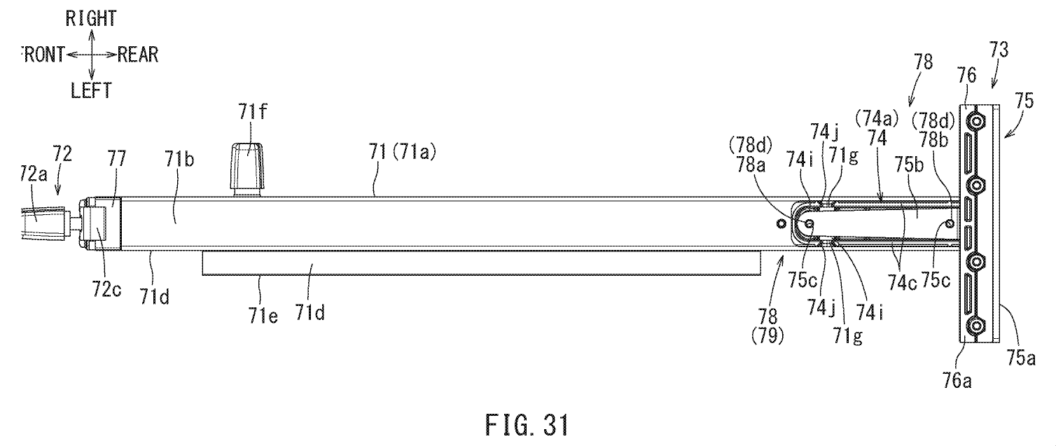

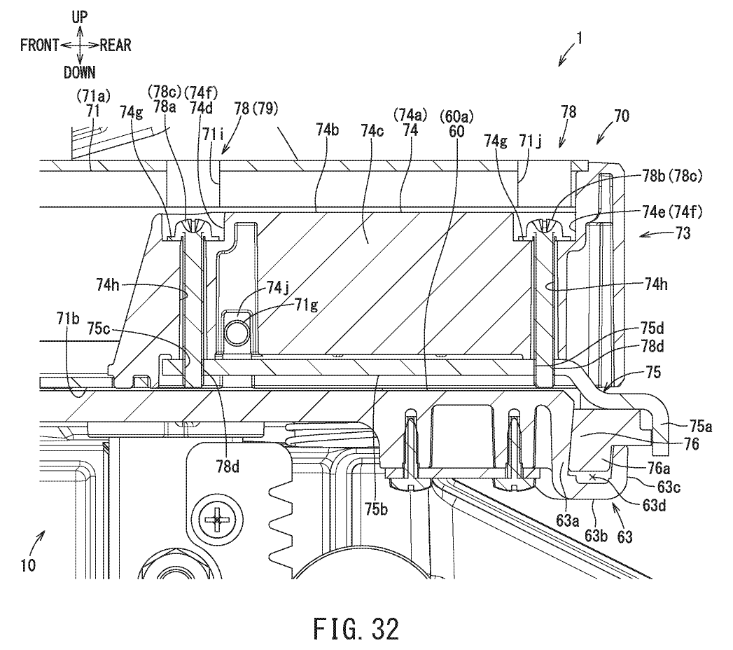

As shown in FIGS. 30 and 31, a front sliding member 77 is provided at the front end of the fence base 71a and behind the pressing portion 72. The front sliding member 77 is a thin plate that is substantially flush with the lower surface 71b of the fence base 71a. The front sliding member 77 is positioned between the fence base 71a and the upper surface 60a of the upper table 60 in the up-down direction when the rip fence 70 is placed on the upper table 60 (see FIG. 3). The front sliding member 77 is provided with a sliding member 76 on a rail-side support body 75 of the support member 73. The sliding member 76 is L-shaped as seen from the left and right sides and extends straight out in the left and right directions. As shown in FIG. 32, the downwardly projecting portion of the L-shaped sliding member 76 is an insertion portion 76a that is inserted into the rail 63. The front sliding member 77 and the sliding member 76 cooperate to slide the rip fence 70 in the left and right direction with respect to the upper table 60. The front sliding member 77 and the sliding member 76 are made of a material with high slidability and, for example, may be made of the same material. The front sliding member 77 and the sliding member 76 are made of synthetic resin, and for example, may be resin such as epoxy resin, polyurethane resin, acetal resin, and more preferably, polyacetal resin.

As shown in FIG. 3, the pressing member 72 has an axially rotatable operation portion 72a, a pressing portion 72b at the rear end of the operation portion 72a, and a leaf spring 72c that enters the rear of the pressing portion 72b. When the rip fence 70 is placed on the upper table 60, the pressing portion 72b faces the front surface of the upper table 60 via the leaf spring 72c. By axially rotating the operation portion 72a in the tightening direction, the pressing portion 72b presses against the front surface of the upper table 60. This allows the rip fence 70 to be fixed to any desired left or right position of the upper table 60. By axially rotating the operation portion 72a in the loosening direction, the pressing force of the pressing portion 72b is released and the rip fence 70 can be slidably moved to any desired left or right position.

As shown in FIG. 32, the rail 63 has an upwardly opening C-shaped as seen from the left and right sides. The rail 63 has a first upright surface 63a, a bottom surface 63b and a second upright surface 63c. The first upright surface 63a extends in a direction that slightly inclines rearward and upward at the rear end of the upper surface 60a. The bottom surface 63b extends substantially horizontal rearwardly from the lower end of the first upright surface 63a. The second upright surface 63c extends upward from the rear end of the bottom surface 63b. The first upright surface 63a and the second upright surface 63c face each other in the front-rear direction. The first upright surface 63a, the bottom surface 63b, and the second upright surface 63c cooperate to form a groove 63d extending in the left-right direction. The distance between the first upright surface 63a and the second upright surface 63c in the front-rear direction is wider at the lower end of the groove 63d and gradually narrows toward the upper end opening of the groove 63d, creating a reverse taper. Therefore, the insertion portion 76a of the sliding member 76 inserted into the groove 63d of the rail 63 is restrained from slipping upward out of the groove 63d.

As shown in FIG. 32, a tongue piece 75a is provided at the rear end of the rail-side support body 75. The tongue piece 75a faces the first upright surface 63a of the rail 63 with the sliding member 76 interposed therebetween in the front-rear direction. Therefore, when the pressing member 72 (see FIG. 3) is tightened, the tongue piece 75a and the first upright surface 63a approach each other with the sliding member 76 interposed therebetween in the front-rear direction. This allows the rip fence 70 to be fixed to the upper table 60 merely by operating the pressing member 72 at the front. Also, by interposing the sliding member 76 made of polyacetal, for example, the position of the rail-side support body 75 is aligned such that the first upright surface 63a and the tongue piece 75a directly face each other. This prevents the rail-side support body 75 from being warped against the rail 63.

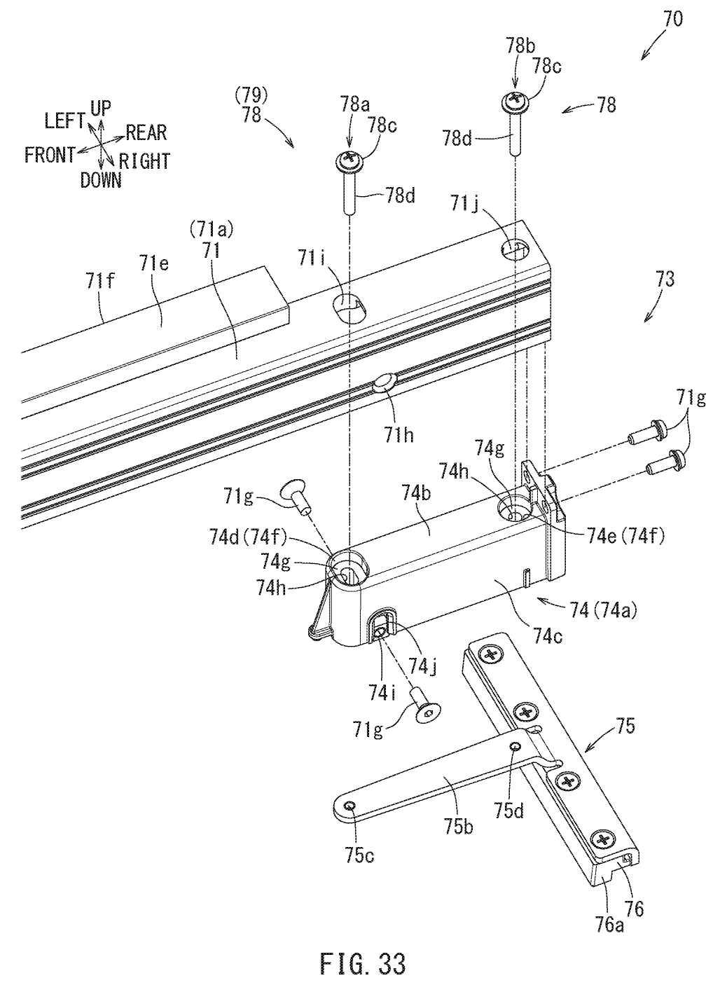

As shown in FIG. 33, the support member 73 has a fence-side support body 74 and a rail-side support body 75. The fence-side support body 74 is box-shaped with an opening at the lower end. The fence side support body 74 is fixed to the fence base 71a in a non-movable manner. The rail-side support body 75 is T-shaped in a top view. The rail-side support body 75 is connected to the fence-side support body 74 via a connecting mechanism 78 in a position adjustable manner.

As shown in FIGS. 15 and 33, the rear upper surface of the fence base 71a is provided with a front through hole 71i and a rear through hole 71j that pass through in the front-rear direction. The rear through hole 71j is substantially circular in shape. The front through hole 71i is an oval shape elongated further in the left-right direction than the rear through hole 71j. A circular insertion hole 71h is formed in the left and right sides of the rear part of the fence base 71a, which penetrate in the left-right directions. Two cylindrical bores, a front cylindrical bore 74d and a rear cylindrical bore 74e, are provided on the upper surface 74b of the fence-side support body 74. The front cylindrical bore 74d and the rear cylindrical bore 74e are provided at substantially the same front and rear positions as the front through hole 71i and the rear through hole 71j of the fence base 71a, respectively.

As shown in FIGS. 32 and 33, the front cylindrical bore 74d has a bore wall 74f that is oval and substantially the same in shape as the front through hole 71i in a top view. A stepped surface 74g that is substantially horizontal is provided at the lower end of the bore wall 74f. In the center of the stepped surface 74g, a leg insertion hole 74h is provided that penetrates in the up-down direction. The leg insertion hole 74h is connected to the inner housing 74a of the fence-side support body 74. The leg insertion hole 74h of the front cylindrical bore 74d has an oval shape with the bore wall 74f one size smaller in the top view. A front screw member 78a, referred to as a pan head screw, for example, is inserted into the front cylindrical bore 74d. A clearance is provided between the bore wall 74f and the head 78c of the front screw member 78a in the horizontal direction. The leg insertion hole 74h is provide to have a size to allow insertion of the leg 78d of the front screw member 78a but not to allow insertion of the head 78c. A clearance is provided between the leg insertion hole 74h and the leg 78d in the horizontal direction. The clearance between the bore wall 74f and the head 78c and the clearance between the leg insertion hole 74h and the leg 78d can be used to adjust the horizontal position of the front screw member 78a with respect to the front cylindrical bore 74d, enabling significant adjustment, particularly in the left-right direction.

As shown in FIGS. 32 and 33, the rear cylindrical bore 74e has a bore wall 74f that is circular and substantially the same in shape as the rear through hole 71j in a top view. Similar to the front cylindrical bore 74d, a substantially horizontal stepped surface 74g and a leg insertion hole 74h that penetrates in the up-down direction are provided. The leg insertion holes 74h are connected to the inner housing 74a of the fence-side support body 74. The leg insertion hole 74h in the rear cylindrical bore 74e is circular in shape with the bore wall 74f one size smaller in the top view. A rear screw member 78b, referred to as a pan head screw, for example, is inserted into the rear cylindrical bore 74e. Similar to the front cylindrical bore 74d, a clearance is provided between the bore wall 74f and the head 78c of the rear screw member 78b in the horizontal direction, and between the leg insertion hole 74h and the leg 78d in the horizontal direction. Therefore, the horizontal position of the rear screw member 78b with respect to the rear cylindrical bore 74e can be adjusted.

As shown in FIGS. 32 and 33, the right and left sides of the fence-side support body 74 are provided with a notch 74j extending upwardly from the lower end and penetrating in the left-right direction. A nut is provided inside the notch 74j as a female thread 74i. A lock screw 71g is inserted through the insertion hole 71h of the fence base 71a and the notch 74j of the fence-side support body 74, and tightened to the female thread 74i. This allows the fence-side support body 74 to be fixed to the fence side support 74 in a non-movable manner.

As shown in FIGS. 31 and 33, the rail-side support body 75 has a tapered portion 75b extending forward and is substantially orthogonally to the sliding member 76. The tapered portion 75b gradually tapers in left-right width as it extends forward. The tapered portion 75b is housed in the housing 74a of the fence-side support body 74. As the tapered portion 75b is tapered toward the front, a large clearance is provided between the tip end (front end) of the tapered portion 75b and the left and right sides of the housing 74a. The length of the rail-side support body 75 in the front-rear direction from the tip end of the tapered portion 75b to the tongue piece 75a may be, for example, 1/3 or less of the length of the fence body 71 in the front-rear direction. Each of the front tip end portion and the rear base of the tapered portion 75b is provided with a female thread 75c that penetrates in the up-down direction.

As shown in FIG. 32, a front screw member 78a inserted into the front cylindrical bore 74d and a rear screw member 78b inserted into the rear cylindrical bore 74e are tightened to the respective female threads 75c. By tightening the front screw member 78a and the rear screw member 78b to the female threads 75c while adjusting the position of the front screw member 78a and the rear screw member 78b, the accuracy of the connecting mechanism 78 that connects the fence-side support body 74 and the rail-side support body 75 can be improved. This increases the accuracy of the perpendicularity between the longitudinal direction of the fence body 71 and the longitudinal direction of the sliding member 76. For example, the rear screw member 78b, which has a smaller range of positional adjustment, is first tightened to the female thread 75c of the rail-side support body 75 (see FIG. 31). While rotating the fence body 71 about the rear screw member 78b, the position of the front screw member 78a, which has a larger range of positional adjustment, is adjusted and then fastened to the female threaded portion 75c of the rail-side support body 75. This improves the efficiency of accurately positioning the rail-side support body 75 relative to the fence-side support body 74.

As shown in FIG. 14, the material contact member 71d is slidably attached to the left side 71c of the fence base 71a. The material contact face 71e of the material contact member 71d extends leftward from the side 71c of the fence base 71a and parallel to the side 71c. An axially rotatable operation portion 71f is provided on the right side of the fence base 71a opposite the material contact member 71d. By tightening the operation portion 71f, the material contact member 71d can be fixed to the fence base 71a at any desired front-rear position. By loosening the operation portion 71f, the locking force is released, allowing the material contact member 71d to slidably move in the front-rear direction with respect to the fence base 71a.

### Blade Cover 80 and Push Stick 85

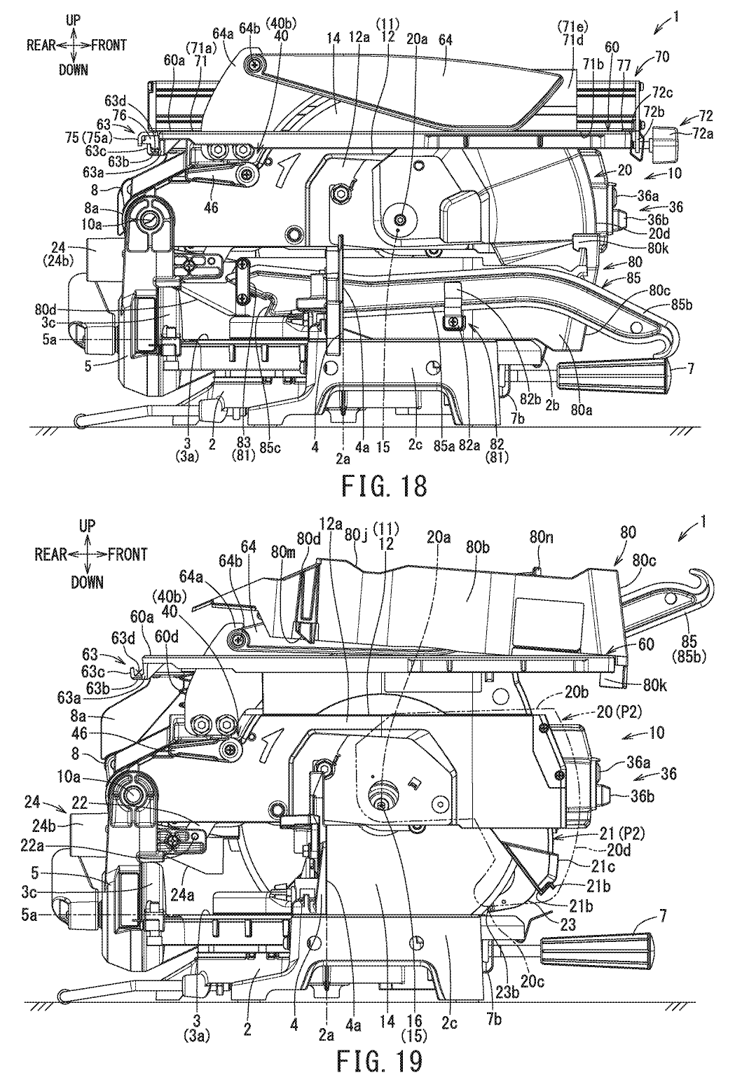

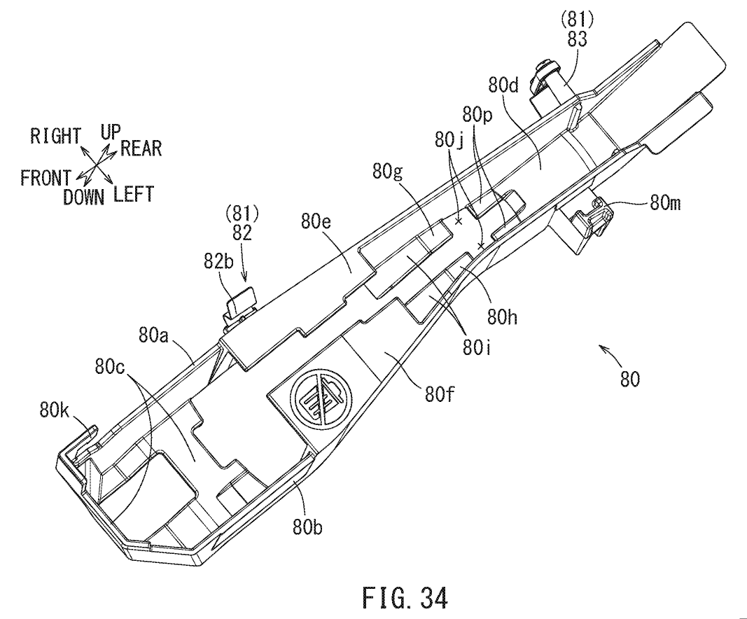

As shown in FIG. 34, the blade cover 80 has a box shape elongated in the front-rear direction. Hereafter, the up-down and left-right directions of the blade cover 80 will be based on the orientation when used in the table saw mode, unless otherwise specifically noted. The blade cover 80 has two side sections, a left lateral side section 80a and a right side section 80b. The left side section 80a and the right side section 80b stand up in the up-down direction and extend elongated in the front-rear direction. The upper edges of the left side section 80a and the right side section 80b are of a substantially constant height from the front end to the rear end. As shown in FIG. 18, the left side section 80a covers the lower portion of saw blade 14 from the left side. The upper edge of the left side section 80a is located immediately below the lower edge of the fixed cover 12 such that the clearance in the up-down direction reduces. As shown in FIGS. 3 and 22, the right side section 80b covers the lower portion of the saw blade 14 from the right side. The upper edge of the right side section 80b is located above and to the right of the lower edge of the fixed cover 12 and covers the fixed cover 12 from the right side.

As shown in FIG. 34, the front ends of the left side section 80a and the right side section 80b are connected in the left-right direction via a front connecting portion 80c. The front connecting portion 80c stands up in the up-down direction. As shown in FIGS. 18 and 22, the upper end of the front connecting portion 80c is located forward and above the lower end of the fixed cover 12 and covers the fixed cover 12 from the front. The front connecting portion 80c covers the lower portion of the saw blade 14 from the front.

As shown in FIG. 34, the lower rear ends of the left side section 80a and the right side section 80b are connected in the left-right direction via a rear connecting portion 80d. The rear connecting portion 80d inclines gradually upward toward the rear. As shown in FIGS. 4 and 18, the rear connecting portion 80d covers the lower portion of the saw blade 14 from the rear. The rear connecting portion 80d extends smoothly from the upper surface 3a of the turntable 3 toward the dust collection port 24b of the dust collection guide 24.

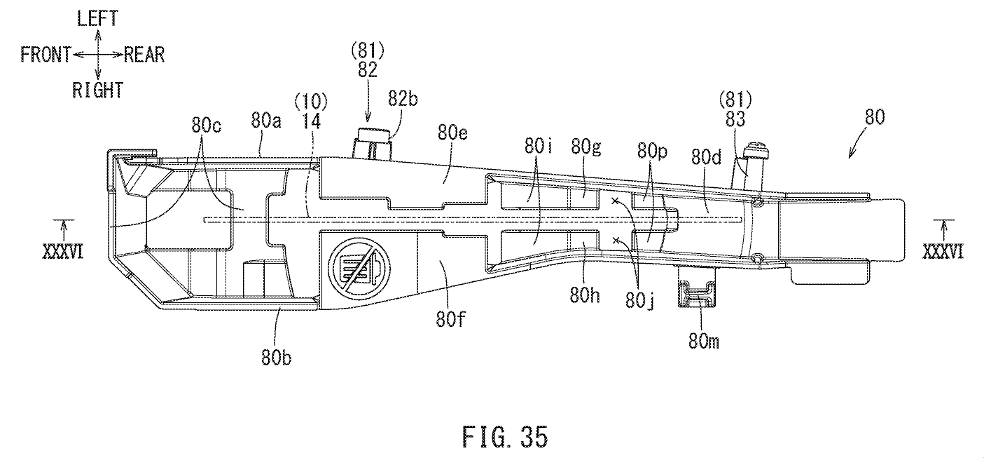

As shown in FIGS. 34 and 35, a left upper surface portion 80e is provided at the upper end of the center of the left side section 80a in the front-rear direction. The left upper surface portion 80e extends substantially horizontal from the left side section 80a toward the right. A right upper surface portion 80f is provided at the upper end of the center of the right side section 80b in the front-rear direction. The right upper surface portion 80f extends substantially horizontal from the right side section 80b toward the left. The two upper surface portions of the left upper surface portion 80e and the right upper surface portion 80f face each other in the left-right direction. The length of the left upper surface portion 80e and the right upper surface portion 80f protruding in the left-right direction is longer than the distance from the saw blade 14, respectively. The left upper surface portion 80e and the right upper surface portion 80f narrow the clearance in the left-right direction with respect to the saw blade 14, respectively (see FIG. 17). This prevents dust from scattering upward from the blade cover 80.

As shown in FIGS. 34 and 35, a left middle lower surface portion 80g is provided at the lower end of the left side section 80a. The left middle lower surface portion 80g is provided behind the left upper surface portion 80e. The left middle lower surface portion 80g extends to the right with substantially the same left-right width as the left upper surface portion 80e. The left middle lower surface portion 80g is provided with an inclined portion 80i that inclines upward toward the rear. A right middle lower surface portion 80h is provided at the lower end of the right side section 80b. The right middle lower surface portion 80h is provided behind the right upper surface portion 80f. The left middle lower surface portion 80g extends to the left with substantially the same left-right width as the left upper surface portion 80e and opposes the left middle lower surface portion 80g in the left-right direction. An inclined portion 80i that inclines upward toward the rear is also provided at the right middle lower surface portion 80h.

As shown in FIGS. 34 and 35, the left middle lower surface portion 80g and right middle lower surface portion 80h narrow the clearance in the left-right direction relative to the saw blade 14, respectively (see FIG. 17). This prevents dust from scattering downward from the blade cover 80. Providing the inclined portions 80i on the left middle lower surface 80g and the right middle lower surface 80h allows dust to be efficiently sent to the rear connecting portion 80d, which inclines upward toward the rear.

As shown in FIGS. 34 and 35, a rear lower surface portion 80p is provided at each of the lower ends of the left side section 80a and the right side section 80b. The rear lower surface portion 80p is provided behind the left middle lower surface portion 80g and the right middle lower surface portion 80h. The rear lower surface portion 80p is integrally connected with the front end of the rear connecting portion 80d. The rear lower surface portion 80p has substantially the same left-right width as the left middle lower surface portion 80g and the right middle lower surface portion 80h and extends in the left-right direction. The rear lower surface portion 80p is located below the rear upper edge of the left middle lower surface portion 80g and the right middle lower surface portion 80h.

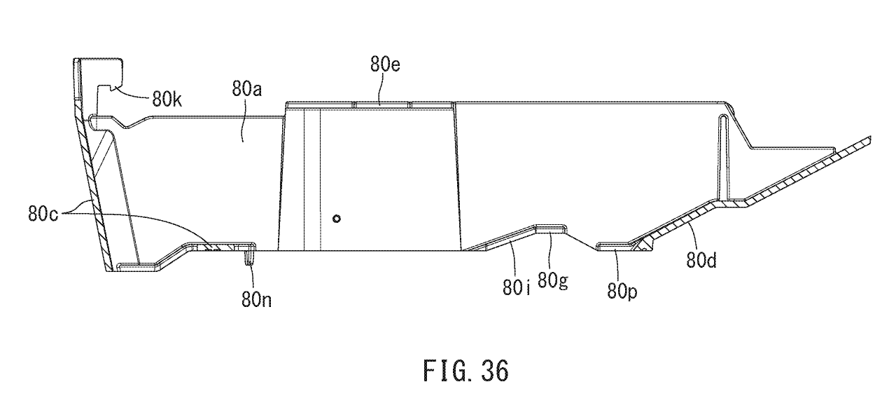

As shown in FIGS. 34 and 35, an opening 80j is provided between the rear lower surface portion 80p and the left middle lower surface portion 80g in the front-rear direction. The opening 80j is also provided between the rear lower surface portion 80p and the right middle lower surface portion 80h in the front-rear direction. Dust leaking from the left middle lower surface portion 80g and the right middle lower surface portion 80h can be recollected on the rear lower surface portion 80p via the opening 80j and can be further sent to the rear connecting portion 80d (see FIG. 36).

As shown in FIG. 34, a hook-shaped engaging portion 80k is provided at the upper left end of the front connecting portion 80c. As shown in FIG. 25, the blade cover 80 can be placed on the upper surface 60a of the upper table 60 in an inverted vertical and horizontal position when used in the tabletop miter saw mode. The blade cover 80 can be placed over the top cover 64. The front connecting portion 80c serves as an enclosure covering the front of the upper portion of the saw blade 14 by placing the blade cover 80 on the upper table 60. This prevents dust from scattering from the through hole 60c (see FIG. 1) in the upper table 60 to the user's side. The engaging portion 80k is hooked so as to hold the front surface of the upper table from above and below. This allows the blade cover 80 to be positioned with respect to the upper table 60.

As shown in FIG. 34, a columnar stopper contact member 80m extending in the up-down direction is provided at the rear right side of the right side section 80b. As shown in FIG. 3, the stopper contact member 80m contacts the cover contact member 53b of the elevation stopper 53 when the blade cover 80 is placed on the turntable 3. As shown in FIG. 36, a lower projection 80n protrudes downward from the lower end of the blade cover 80. The lower projection 80n engages with the turntable 3 (FIG. 1). This prevents dust in the blade cover 80 from scattering through the clearance between the blade cover 80 and the turntable 3.

As shown in FIG. 18 and 34, an elastic member 82 is provided as an attachment portion 81 to the right of the center of the left side section 80a in the front-rear direction. The elastic member 82 is, for example, a leaf spring. The elastic member 82 is fixed to the left side section 80a at the lower base 82a. The elastic member 82 can elastically hold the accessory with the upwardly extending retaining strip 82b. The elastic member 82 may, for example, removably hold the center portion of the stick body 85a of the push stick 85.

As shown in FIGS. 18 and 34, an insertion hole 83 penetrating in the front-rear direction is formed at the rear right side of the left side section 80a as an attachment portion 81. An accessory can be inserted through the insertion hole 83 to hold the accessory. For example, the tip end on the side of the material contact member 85c of the push stick 85 may be inserted through the insertion hole 83 and held. By holding the push stick 85 with the elastic member 82 and the insertion hole 83, a handle 85b of the push stick 85 extends forward. The handle 85b extends forward from, for example, the outer circumferential wall 3b of the turntable 3. A portion of the handle 85b is located below the upper surface 3a of the turntable 3. The push stick 85, the elastic member 82, and the insertion hole 83 are all positioned entirely below the upper surface 60a of the upper table 60 when used in the table saw mode. As shown in FIG. 16, the push stick 85 is held so as to fit between the left and right ends of the turntable 3 in the left-right direction.

As described-above, as shown in FIGS. 3 and 14, a stationary machining device 1 includes an upper table 60, a rail 63 and a fence body 71. A workpiece W that moves from front to rear when machining is placed on the upper table 60. The rail 63 extends left and right along a rear portion of the upper table 60. The fence body 71 is disposed on the upper table 60 and guides the workpiece W while machining. The stationary machining device 1 includes a support member 73 and a pressing member 72. The support member 73 is provided at the rear of the fence body 71 and movably attached to the rail 63. The pressing member 72 is provided at the front of the fence body 71 and pushes the front of the upper table 60 forward, cooperating with the support member 73 to fix the fence body 71 on the upper table 60.

Therefore, by interposing the upper table 60 between the support member 73 and the pressing member 72 in the front-rear direction, the fence body 71 of the rip fence 70 can be securely fixed on the upper table 60. The operability for fixing the rip fence 70 on the upper table 60 can also be enhanced by providing the pressing member 72 at the front side where the operator is positioned during cutting.

As shown in FIGS. 3 and 32, the rail 63 has a first upright surface 63a oriented rearward. The support member 73 has a tongue piece 75a extending rearward from the first upright surface 63a. A sliding member 76 is provided that is mounted on one of the first upright surface 63a and the tongue piece 75a, and slidably moves with respect to the other. Therefore, it is possible to maintain the rip fence 70 to be fixed on the upper table 60 by allowing the first upright surface 63a and the tongue piece 75a to face each other in the front-right direction. Furthermore, slidable movement of the first upright surface 63a or the tongue piece 75a with respect to the sliding member 76 allows the rip fence 70 to smoothly move with respect to the rail 63 in the left-right direction. This improves the positioning accuracy of the rip fence 70 relative to the upper table 60.

As shown in FIGS. 3 and 32, the rail 63 has a first upright surface 63a oriented rearward. The sliding member 76 that contacts the first upright surface 63a from the rear and moves slidably is attached to the support member 73. Therefore, with the upper table 60 interposed between the pressing member 72 and the sliding member 76 provided to the support member 73 in the front-rear direction, the rip fence 70 can be securely fixed to the upper table 60. Further, the slidability of the rail 63 and the support member 73 may be maintained while providing the rail 63 to have a simple structure.

As shown in FIG. 3, the sliding member 76 may be made of epoxy resin, polyurethane resin or acetal resin. Therefore, the wear of the sliding member 76 may be suppressed against repeated sliding.

As shown in FIG. 3, the sliding member 76 may be made of polyacetal. Therefore, the sliding performance of the sliding member 76 may be enhanced. Furthermore, when applying pressing force to the front surface of the upper table 60 via the pressing member 72, the high sliding performance of the sliding member 76 enables alignment of the support member's 73 position. Consequently, warping of the support member 73 relative to the rail 63 can be suppressed.

As shown in FIG. 3, the stationary machining device 1 includes a front sliding member 77. The front sliding member 77 is mounted on one of the front lower surface 71b of the fence body 71 and the front upper surface 60a of the upper table 60, and slidably moves with respect to the other. The front sliding member 77 is made of epoxy resin, polyurethane resin or acetal resin. Therefore, the rear sliding member 76 and the front sliding member 77 cooperate to enhance the sliding performance of the rip fence 70 relative to the upper table 60.

As shown in FIGS. 3 and 32, the rail 63 has a bottom surface 63b, a second upright surface 63c and a groove 63d. The bottom surface 63b extends rearward from a lower end of the first upright surface 63a. The second upright surface 63c stands upward from the rear end of the bottom surface 63b. The groove 63d is defined by the first upright surface 63a, the bottom surface 63b and the second upright surface 63c, and into which the sliding member 76 is inserted. Therefore, the sliding member 76 is inserted between the first upright surface 63a and the second upright surface 63c in the front-rear direction. This allows the sliding member 72 to be favorably fixed within the groove 63d of the rail 63 when applying the pressing force rearward with the pressing member 72.

As shown in FIG. 32, the first upright surface 63a inclines upward towards the rear. Therefore, when the rip fence 70 is fixed to the upper table 60, the sliding member 76 may be prevented from slipping upward out of the rail 63.

As shown in FIGS. 32 and 33, the support member 73 has a rail-side support body 75, a fence-side support body 74, a connecting mechanism 78, and a positioning mechanism 79. The rail-side support body 75 slidably moves relative to the rail 63. The fence-side support body 74 is fixed to the fence body 71. The connecting mechanism 78 connects the rail-side support body 75 and the fence-side support body 74 so as to be position adjustable in the horizontal direction. The positioning mechanism 79 aligns the position of the fence-side support body 74 with respect to the rail-side support body 75. Therefore, the perpendicularity of the fence body 71 with respect to the rail 63 can be adjusted by aligning the horizontal position of the fence-side support body 74 with respect to the rail-side support body 75. This allows the parallelism of the fence body 71 with respect to the extension direction (front-rear direction) of the side surface of the saw blade 14 to be adjusted.

As shown in FIG. 32, the fence-side support body 74 is provided with a receiving portion 74a into which the rail-side support body 75 is inserted from the rear. Accordingly, the connecting mechanism 78 and the positioning mechanism 79 can be provided in a compact manner.

As shown in FIGS. 31 and 33, the rail-side support body 75 is tapered toward the front as seen in a plan view. Therefore, the front portion of the rail-side support body 75 far from the rail 63 has a greater allowable range of movement in the left-rear direction relative to the fence-side support body 74. Accordingly, the adjustment range of the perpendicularity of the fence body 71 with respect to the rail 63 can be increased. As a result, the adjustment range of the parallelism of the fence body 71 with respect to the front-rear direction may be increased.

As shown in FIGS. 32 and 33, the connecting mechanism 78 has screw members 78a, 78b, cylindrical bores 74d,74e, and a female thread 75c. The cylindrical bores74d, 74e are provided in the fence-side support body 74 into which the screw members 78a, 78b are inserted from above and allow the radial movement of the screw members 78a, 78b. The female thread 75c is provided in the rail-side support body 75 into which the legs 78d of the screw member 78a, 79b are screwed. The positioning mechanism 79 includes the screw members 78a, 78b having a head 78c that contacts the stepped surface 74g of the cylindrical bores 74d, 74e by screwing the screw members 78a, 78b into the female thread 75c. Accordingly, the screw members 78a, 78b can be tightened or loosened from above the fence body 71. Therefore, the operability for positioning the fence-side support body 74 relative to the rail-side support body 75 may be improved.

As shown in FIGS. 32 and 33, the fence-side support body 74 includes a front cylindrical bore 74d and a rear cylindrical bore 74e that are positioned at the front and rear as a cylindrical bore. A radial clearance between the rear cylindrical bore 74e and the rear screw member 78b that is the screw member inserted into the rear cylindrical bore 74e, is smaller than the radial clearance between the front cylindrical bore 74d and the front screw member 78a that is a screw member inserted into the front cylindrical bore 74d. The fence body 71 is allowed to rotate utilizing the radial clearance between the front cylindrical bore 74d and the front screw member 78a with the rear screw member 78b, which is inserted into the rear cylindrical bore 74e, as a center of rotation of the fence body 71. As a result, the operability for positioning the fence-side support body 74 relative to the rail-side support boy 75 may be improved.

As shown in FIG. 31, the length of the rail-side support body 75 in the front-rear direction is one-third or less than the length of the fence body 71 in the front-rear direction. Therefore, the adjustment range of the parallelism of the fence body 71 in the front-rear direction may be increased.

As shown in FIG. 33, an insertion hole 71h is formed in the lateral side of the fence body 71. A lock screw 71g for fixing the fence-side support body 74 to the fence body 71 is inserted into the insertion hole 71h. A female thread 74i into which the lock screw 71g is screwed is formed in the lateral side of the fence-side support body 74. Therefore, when fixing the rip fence 70 on the upper table 60 utilizing the pressing force of the pressing member 72, the horizontal displacement of the fence-side support body 74 relative to the fence body 71 may be prevented. This allows the rip fence 70 to be fixed on the upper table 60 as the pressing member 72 presses the upper table 60 with minimal pressing force.

As shown in FIG. 14, the fence body 71 has a fence base 71a, a material contact member 71d and a material contact face 71e. The fence base 71a is supported by the support member 73. The material contact member 71d is attached to the fence base 71a so as to be position adjustable in the front-rear direction. The material contact face 71e is provided on the material contact member 71d for the workpiece W to come in contact. Therefore, the material contact face of the material contact member 71d is located between the fence base 71a and the saw blade 14 in the left-right direction. By adjusting the front and rear positions of the material contact face, it is possible to prevent the workpiece W from being stuck between the rip fence 70 fixed on the upper table 60 and the riving knife 64a located behind the saw blade 14.

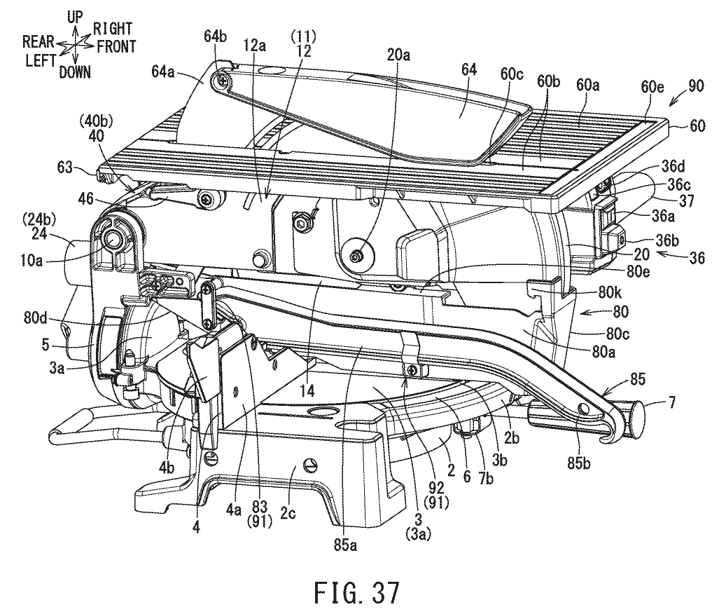

Next, a second embodiment of the present disclosure will be described with reference to FIG. 37. The tabletop miter saw 90 according to the second embodiment has an elastic member 92 as an attachment portion 91 instead of the elastic member 82 of attachment portion 81 shown in FIG. 18. In the following description, only the parts that differ from the first embodiment will be described in detail. The elastic member 92 is similar in shape to the elastic member 82 and is provided below the elastic member 82. Therefore, the push stick 85 held by the elastic member 92 and the insertion hole 83 in the attachment portion 91 is inclined downward toward the front than in the first embodiment. Therefore, the length of the handle 85b of the push stick 85, which is located below the upper surface 3a of the turntable 3, becomes longer. This allows the handle 85b of the push stick 85 to be placed in a position that is easily visible to the user located at the front side of the tabletop miter saw 90.

Various modifications may be made to the tabletop miter saw 1 and 90 according to the present embodiments described above. For example, it may be other types of stationary machining devices that use a rip fence for a flip-over saw, a table saw without a turntable, a stationary band saw, or a stationary planer.

A configuration in which the battery attachment portion 33 is provided on the cutting tool unit 10 was described as an example. Instead of this, for example, a battery separate from the cutting tool unit may be used to supply electric power to the cutting tool unit via a cord or the like. The capacity of the battery that can be used is not limited to those described as examples, and may be changed as necessary.

In the guide mechanism 40, a configuration in which the contact member 48 engages the rear guide member 45 and presses the rear guide member 45 and the fixed cover 12 together to fix them in position was described as an example. Instead of this, for example, a configuration in which the contact member engages the fixed cover to fix the guide member and the fixed cover may be adopted. The front locking operation member 43 and the rear locking operation member 46 may either be located on the opposite side from the motor 30 (left side) with respect to the saw blade 14, or both may be located on the left side.

The first connecting portion 20a, which is the center of rotation of the movable cover 20, and the second connecting portion 21a, which is the center of rotation of the auxiliary cover 21, may be located at different positions from each other, for example on the same side to the saw blade 14 on both left and right sides. It is even more preferable, if they are arranged such that the rotation radius of the auxiliary cover 21 is reduced.

The materials and shapes of the sliding member 76 and the front sliding member 77 shall not be limited to those described as examples, but may be modified as necessary. For example, one or both of the sliding member and the front sliding member may be mounted on the upper table 60 side.

Any or all of the upper surface, middle lower surface portion, inclined portion, opening, etc. provided on the blade cover 80 may be provided only on one side of the saw blade 14. The attachment portion 81 may be provided on either left or right side of blade cover 80. The attachment portion 81 may hold accessories other than the push stick 85, such as a hexagonal wrench.

According to another aspect of the present disclosure, the rip fence 70 may further include a positive locking mechanism to prevent movement of the rear support member 73 relative to the rail 63. For example, a connecting rod (not shown) may extend through the interior of the fence body 71 in the front-rear direction. The front end of the connecting rod is operatively coupled to the operation portion 72a of the pressing member 72. The rear end of the connecting rod is coupled to a clamping member provided within the rail-side support body 75. When the operation portion 72a is operated, the connecting rod pulls the clamping member forward, causing it to physically clamp the upright surface 63a or the second upright surface 63c of the rail 63. This configuration ensures that the rip fence 70 is securely locked to the upper table 60 even if the upper table 60 flexes slightly, thereby preventing the rip fence 70 from lifting or shifting during heavy-load cutting operations.

The stationary machining device according to claim 1, further comprising: a locking linkage extending through the fence body in the front-rear direction, the locking linkage having a first end operatively coupled to the pressing member and a second end; and a clamping member provided on the support member and coupled to the second end of the locking linkage, wherein operation of the pressing member causes the locking linkage to actuate the clamping member to clamping engagement with the rail.

What is claimed is:

1. A stationary machining device comprising:
a table configured to support a workpiece;
a rail extending a left-right direction along a rear portion of the table;
a fence body disposed on the table and configured to guide the workpiece during machining;
a support member provided at a rear portion of the fence body and movably coupled to the rail; and
a pressing member provided at a front portion of the fence body, wherein the pressing member is configured to apply a pressing force against a front portion of the table in a forward direction, thereby cooperating with the support member to fix the fence body to the table.

2. The stationary machining device according to claim 1, wherein:
the rail includes a first upright surface oriented rearward,
the support member includes a tongue piece extending rearward from the first upright surface, and
the stationary machining device further comprises a sliding member disposed between the first upright surface and the tongue piece, the sliding member being mounted on one of the first upright surface or the tongue piece and configured to slide relative to the other.

3. The stationary machining device according to claim 1, wherein:
the rail includes a first upright surface oriented rearward, and
a sliding member that contacts the first upright surface from the rear and moves slidably is attached to the support member.

4. The stationary machining device according to claim 2, wherein the sliding member is formed of material selected from epoxy resin, polyurethane resin or acetal resin.

5. The stationary machining device according to claim 4, wherein the sliding member is made of polyacetal.

6. The stationary machining device according to claim 2, further comprising a front sliding member that is mounted on one of a front lower surface of the fence body and a front upper surface of the table, and slidably moves with respect to the other, wherein the front sliding member is made of epoxy resin, polyurethane resin or acetal resin.

7. The stationary machining device according to claim 2, wherein the rail further comprises
a bottom surface extending rearward from a lower end of the first upright surface; and
a second upright surface extending upward from a rear end of the bottom
surface, and
wherein the first upright surface, the bottom surface, and the second upright surface define a groove, and wherein the sliding member is inserted into the groove.

8. The stationary machining device according to claim 7, wherein the first upright surface is inclined upward towards the rear to create a reverse taper within the groove, thereby restricting the sliding member from slipping upward out of the groove.

9. The stationary machining device according to claim 1, wherein the support member comprises:
a rail-side support body movably engaged with the rail;
a fence-side support body fixed to the fence body; and
a connecting mechanism connecting the rail-side support body and the fence-side support body, wherein the connecting mechanism is configured to allow positional adjustment of the fence-side support body relative to the rail-side support body in a horizontal direction.

10. The stationary machining device according to claim 9, wherein the fence-side support body comprises a receiving portion, and wherein the rail-side support body is inserted into the receiving portion from the rear.

11. The stationary machining device according to claim 10, wherein the rail-side support body is tapered toward a front as seen in a plan view.

12. The stationary machining device according to claim 9, wherein the connecting mechanism includes:
a screw member;
a cylindrical bore provided in the fence-side support body into which the screw member is inserted from above, and configured to allow a radial movement of the screw member; and
a female thread provided in the rail-side support body into which a leg of the screw member is screwed,
wherein the positioning mechanism includes the screw member having a head that contacts an upper surface of the cylindrical bore by screwing the screw member into the female thread.

13. The stationary machining device according to claim 12, wherein the fence-side support body includes a front cylindrical bore and a rear cylindrical bore that are positioned at front and rear as the cylindrical bore,
wherein a radial clearance between the rear cylindrical bore and a rear screw member that is the screw member inserted into the rear cylindrical bore is smaller than a radial clearance between the front cylindrical bore and a front screw member that is the screw member inserted into the front cylindrical bore.

14. The stationary machining device according to claim 9, wherein a length of the rail-side support body in a front-rear direction is one-third or less than a length of the fence body in the front-rear direction.

15. The stationary machining device according to claim 9, wherein the fence-side support body comprises a lateral side having a female thread formed therein, wherein the fence body comprises a lateral side having an insertion hole, and wherein a lock screw is inserted through the insertion hole and tightened into the female thread to fix the fence-side support body to the fence body.

16. The stationary machining device according to claim 1, wherein the fence body has a fence base supported by the support member, a material contact member attached to the fence base so as to be position adjustable in the front-rear direction, and a material contact face provided on the material contact member for the workpiece to come in contact.

17. The stationary machining device according to claim 8, wherein the rail-side support body comprises a tapered portion that tapers toward the front in a plan view, such that a clearance is defined between a front tip of the tapered portion and an inner wall of the receiving portion to allow horizontal rotational adjustment of the rail-side support body.

18. The stationary machining device according to claim 9, wherein the connecting mechanism comprises a screw member having a head and a leg, a cylindrical bore provided in the fence-side support body, configured to receive the screw member from above, and a female thread provided in the rail-side support body into which the leg of the screw member is screwed, wherein the cylindrical bore has a diameter larger than a diameter of the screw member leg to define a radial clearance allowing horizontal movement of the screw member within the cylindrical bore.

19. The stationary machining device according to claim 18, wherein the cylindrical bore comprises a front cylindrical bore and a rear cylindrical bore positioned rearward of the front cylindrical bore, wherein the screw member comprises a front screw member and a rear screw member, and wherein a radial clearance between the rear cylindrical bore and the rear screw member is smaller than a radial clearance between the front cylindrical bore and the front screw member, such that the fence body is rotatable about the rear screw member for adjustment.

20. The stationary machining device according to claim 1, further comprising a front sliding member mounted on one of a front lower surface of the fence body or a front upper surface of the table, wherein the front sliding member is configured to slide against the other of the front lower surface of the fence body or the front upper surface of the table, and wherein the front sliding member is made of resin.
